(19) United States
(12) Patent Application Publication
(10) Pub. No.: US 2011/0170604 A1
(43) Pub. Date: Jul. 14, 2011

(54) IMAGE PROCESSING DEVICE AND METHOD

(76) Inventors: Kazushi Sato, Kanagawa (JP); Yoichi Yagasaki, Tokyo (JP)

(21) Appl. No.: 13/119,715

(22) PCT Filed: Sep. 24, 2009
(86) PCT No.: PCT/JP2009/066492

§ 371 Date: Mar. 17, 2011

(30) Foreign Application Priority Data
Sep. 24, 2008 (JP) 2008-243961

(51) Int. Cl. H04N 7/12

(52) U.S. Cl. 375/240.16; 375/E07.123; 375/E07.243

(57) ABSTRACT

The present invention relates to an image processing device and method whereby deterioration in compression efficiency can be suppressed without increasing computation amount while improving predictive accuracy.

A motion vector Ptmmv for moving, based on distance tn-1 on the temporal axis between this frame Fn and a reference frame Fn-1, and distance tn-2 on the temporal axis between the reference frame Fn-1 and a reference frame Fn-2, a block blkn-1 in parallel with the reference frame Fn-2 is obtained. Prediction error between the block blkn-1 and a block blkn-2 is calculated based on SAD to obtain SAD2. A cost function evtm for evaluating the precision of a motion vector tmmv based on SAD1 and SAD2.

### TECHNICAL FIELD

The present invention relates to an image processing device and method, and particularly relates to an image processing device and method whereby deterioration in compression efficiency can be suppressed without increasing computation amount while improving predictive accuracy.

### BACKGROUND ART

In recent years, there is widespread use of devices which perform compression encoding of images using formats such as MPEG with which compression is performed by orthogonal transform such as discrete cosine transform and the like and motion compensation, using redundancy inherent to image information, aiming for highly-efficient information transmission and accumulation when handling image information as digital.

In particular, MPEG2 (ISO/IEC 13818-2) is defined as a general-purpose image encoding format, which is a standard covering both interlaced scanning images and progressive scanning images, and standard-resolution images and high-resolution images, and is currently widely used in a broad range of professional and consumer use applications. For example, with an interlaced scanning image with standard resolution of 720×480 pixels, high compression and good image quality can be realized by applying a code amount (bit rate) of 4 to 8 Mbps, and with an interlaced scanning image with high resolution of 1920×1088 pixels, 18 to 22 Mbps, by using the MPEG2 compression format.

MPEG2 was primarily for high-quality encoding suitable for broadcasting, but did not handle code amount (bit rate) lower than MPEG1, i.e., high-compression encoding formats. Due to portable terminals coming into widespread use, it is thought that demand for such encoding formats will increase, and accordingly the MPEG4 encoding format has been standardized. As for an image encoding format, the stipulations thereof were recognized as an international Standard as ISO/IEC 14496-2 in December 1998.

Further, in recent years, normalization of a Standard called H.26L (ITU-T Q6/16 VCEG) is proceeding, initially aiming for image encoding for videoconferencing. While H.26L requires a greater computation amount for encoding and decoding thereof as compared with conventional encoding formats such as MPEG2 and MPEG4, it is known that a higher encoding efficiency is realized. Also, currently, standardization including functions not supported by H.26L to realize higher encoding efficiency is being performed based on H.26L, as Joint Model of Enhanced-Compression Video Coding. The schedule of standardization is to make an international Standard called H.264 and MPEG-4 Part 10 (Advanced Video Coding, hereinafter written as AVC) by March of 2003.

With AVC encoding, motion prediction/compensation processing is performed, whereby a great amount of motion vector information is generated, leading to reduced efficiency if encoded in that state. Accordingly, with the AVC encoding format, reduction of motion vector encoding information is realized by the following techniques.

For example, prediction motion vector information of a motion compensation block which is to be encoded is generated by median operation using motion vector information of an adjacent motion compensation block already encoded.

Also, with AVC, multi-reference frame (Multi-Reference Frame), a format which had not been stipulated in convention image information encoding formats such as MPEG2 and H.263 and so forth, is stipulated. That is to say, with MPEG2 and H.263, only one reference frame stored in frame memory had been referenced in the case of a P picture, whereupon motion prediction/compensation processing was performed, but with AVC, multiple reference frames can be stored in memory, with different memory being referenced for each block.

Now, even with median prediction, the percentage of motion vector information in the image compression information is not small. Accordingly, a proposal has been made to search, from a decoded image, a region of the image with great correlation with the decoded image of a template region that is part of the decoded image, as well as being adjacent to a region of the image to be encoded in a predetermined positional relation, and to perform prediction based on the predetermined positional relation with the searched region (for example, use Patent Document 1).

This method is called template matching, and uses a decoded image for matching, so the same processing can be used at the encoding device and decoding device by determining a search range beforehand. That is to say, deterioration in encoding efficiency can be suppressed by performing the prediction/compensation processing such as described above at the decoding device as well, since there is no need to have motion vector information within image compression information from the encoding device.

Also, with template matching, multi-reference frame can be handled as well.

### CITATION LIST

### Patent Literature

PTL 1: Japanese Unexamined Patent Application Publication No. 2007-43651

### SUMMARY OF INVENTION

### Technical Problem

However, with template matching, matching is performed using not a pixel value included in the region of an actual image to be encoded but a peripheral pixel value of this region, and accordingly leads to a problem wherein predictive accuracy deteriorates.

The present invention has been made in light of such a situation, in order to enable deterioration in compression efficiency to be suppressed without increasing computation amount while improving predictive accuracy.

### Solution to Problem

An image processing device according to a first aspect of the present invention includes: first cost function value calculating means configured to determine, based on a plurality of candidate vectors serving as motion vector candidates of a current block to be decoded, a template region adjacent to the current block to be decoded in predetermined positional relationship with a first reference frame that has been decoded, and to calculate a first cost function value to be obtained by matching processing between a pixel value of the template region and a pixel value the region of the first reference frame; second cost function value calculating means configured to calculate, based on a translation vector calculated based on the candidate vectors, with a second reference frame that has been decoded, a second cost function value to be obtained by matching processing between a pixel value of a block of the first reference frame, and a pixel value of a block of the second reference frame; and motion vector determining means configured to determine a motion vector of a current block to be decoded out of a plurality of the candidate vectors based on an evaluated value to be calculated based on the first cost function value and the second cost function value.

In the event that distance on the temporal axis between a frame including the current block to be decoded and the first reference frame is represented as tn-1, distance on the temporal axis between the first reference frame and the second reference frame is represented as tn-2, and the candidate vector is represented as tmmv, the translation vector Ptmmv may be calculated according to

Ptmmv=(tn−2/tn−1)×tmmv.

The translation vector Ptmmv may be calculated by approximating (tn-2/tn-1) in the computation equation of the translation vector Ptmmv to a form of n/2^{m} with n and m as integers.

Distance tn-2 on the temporal axis between the first reference frame and the second reference frame, and distance tn-1 on the temporal axis between a frame including the current block to be decoded and the first reference frame may be calculated using POC (Picture Order Count) determined in the AVC (Advanced Video Coding) image information decoding method.

In the event that the first cost function value is represented as SAD1, and the first cost function value is represented as SAD2, the evaluated value etmmv may be calculated by an expression using weighting factors α and β of

evtm=α×SAD1+β×SAD2.

Calculations of the first cost function and the second cost function may be performed based on SAD (Sum of Absolute Difference).

Calculations of the first cost function and the second cost function may be performed based on the SSD (Sum of Square Difference) residual energy calculation method.

An image processing method according to the first aspect of the present invention includes the steps of: determining, with an image processing device, based on a plurality of candidate vectors serving as motion vector candidates of a current block to be decoded, a template region adjacent to the current block to be decoded in predetermined positional relationship with a first reference frame that has been decoded, and calculating a first cost function value to be obtained by matching processing between a pixel value of the template region and a pixel value of the region of the first reference frame; calculating, with the image processing device, based on a translation vector calculated based on the candidate vectors, with a second reference frame that has been decoded, a second cost function value to be obtained by matching processing between a pixel value of a block of the first reference frame, and a pixel value of a block of the second reference frame; and determining, with the image processing device, a motion vector of a current block to be decoded out of a plurality of the candidate vectors based on an evaluated value to be calculated based on the first cost function value and the second cost function value.

With the first aspect of the present invention, based on a plurality of candidate vectors serving as motion vector candidates of a current block to be decoded, a template region adjacent to the current block to be decoded in predetermined positional relationship is determined with a first reference frame that has been decoded, a first cost function value to be obtained by matching processing between a pixel value of the template region and a pixel value of the region of the first reference frame is calculated, and based on a translation vector calculated based on the candidate vectors, with a second reference frame that has been decoded, a second cost function value to be obtained by matching processing between a pixel value of a block of the first reference frame, and a pixel value of a block of the second reference frame is calculated, and based on an evaluated value to be calculated based on the first cost function value and the second cost function value, a motion vector of a current block to be decoded out of a plurality of the candidate vectors is determined.

An image processing device according to a second aspect of the present invention includes: first cost function value calculating means configured to determine, based on a plurality of candidate vectors serving as motion vector candidates of a current block to be encoded, with a first reference frame obtained by decoding a frame that has been encoded, a template region adjacent to the current block to be encoded in predetermined positional relationship, and to calculate a first cost function value to be obtained by matching processing between a pixel value of the template region and a pixel value the region of the first reference frame; second cost function value calculating means configured to calculate, based on a translation vector calculated based on the candidate vectors, with a second reference frame obtained by decoding a frame that has been encoded, a second cost function value to be obtained by matching processing between a pixel value of a block of the first reference frame, and a pixel value of a block of the second reference frame; and motion vector determining means configured to determine a motion vector of a current block to be encoded out of a plurality of the candidate vectors based on an evaluated value to be calculated based on the first cost function value and the second cost function value.

An image processing method according to the first aspect of the present invention includes the steps of: determining, with an image processing device, based on a plurality of candidate vectors serving as motion vector candidates of a current block to be encoded, with a first reference frame obtained by decoding a frame that has been encoded, a template region adjacent to the current block to be encoded in predetermined positional relationship, and calculating a first cost function value to be obtained by matching processing between a pixel value of the template region and a pixel value of the region of the first reference frame; calculating, with the image processing device, based on a translation vector calculated based on the candidate vectors, with a second reference frame obtained by decoding a frame that has been encoded, a second cost function value to be obtained by matching processing between a pixel value of a block of the first reference frame and a pixel value of a block of the second reference frame; and determining, with the image processing device, a motion vector of a current block to be encoded out of a plurality of the candidate vectors based on an evaluated value to be calculated based on the first cost function value and the second cost function value.

With the second aspect of the present invention, based on a plurality of candidate vectors serving as motion vector candidates of a current block to be encoded, with a first reference frame obtained by decoding a frame that has been encoded, a template region adjacent to the current block to be encoded in predetermined positional relationship is determined, a first cost function value to be obtained by matching processing between a pixel value of the template region and a pixel value of the region of the first reference frame is calculated, and based on a translation vector calculated based on the candidate vectors, with a second reference frame obtained by decoding a frame that has been encoded, a second cost function value to be obtained by matching processing between a pixel value of a block of the first reference frame and a pixel value of a block of the second reference frame is calculated, and based on an evaluated value to be calculated based on the first cost function value and the second cost function value, a motion vector of a current block to be encoded out of a plurality of the candidate vectors is determined.

### Advantageous Effects of Invention

According to the present invention, deterioration in compression efficiency can be suppressed without increasing computation amount while improving predictive accuracy.

### BRIEF DESCRIPTION OF DRAWINGS

FIG. 1 is a block diagram illustrating the configuration of an embodiment of an image encoding device to which the present invention has been applied.

FIG. 2 is a diagram describing variable block size motion prediction/compensation processing.

FIG. 3 is a diagram describing quarter-pixel precision motion prediction/compensation processing.

FIG. 4 is a flowchart describing encoding processing of the image encoding device in FIG. 1.

FIG. 5 is a flowchart describing the prediction processing in FIG. 4.

FIG. 6 is a diagram describing the order of processing in the case of a 16×16 pixel intra prediction mode.

FIG. 7 is a diagram illustrating the types of 4×4 pixel intra prediction modes for luminance signals.

FIG. 8 is a diagram illustrating the types of 4×4 pixel intra prediction modes for luminance signals.

FIG. 9 is a diagram describing the directions of 4×4 pixel intra prediction.

FIG. 10 is a diagram describing 4×4 pixel intra prediction.

FIG. 11 is a diagram describing encoding with 4×4 pixel intra prediction modes for luminance signals.

FIG. 12 is a diagram illustrating the types of 16×16 pixel intra prediction modes for luminance signals.

FIG. 13 is a diagram illustrating the types of 16×16 pixel intra prediction modes for luminance signals.

FIG. 14 is a diagram describing 16×16 pixel intra prediction.

FIG. 15 is a diagram illustrating the types of intra prediction modes for color difference signals.

FIG. 16 is a flowchart for describing intra prediction processing.

FIG. 17 is a flowchart for describing inter motion prediction processing.

FIG. 18 is a diagram describing an example of a method for generating motion vector information.

FIG. 19 is a diagram describing the inter template matching method.

FIG. 20 is a diagram describing multi-reference frame motion prediction/compensation processing method.

FIG. 21 is a diagram describing about improvement in the precision of motion vectors searched by inter template matching.

FIG. 22 is a flowchart describing inter template motion prediction processing.

FIG. 23 is a block diagram illustrating an embodiment of an image decoding device to which the present invention has been applied.

FIG. 24 is a flowchart describing decoding processing of the image decoding device shown in FIG. 23.

FIG. 25 is a flowchart describing the prediction processing shown in FIG. 24.

FIG. 26 is a diagram illustrating an example of expanded block size.

FIG. 27 is a block diagram illustrating a primary configuration example of a television receiver to which the present invention has been applied.

FIG. 28 is a block diagram illustrating a primary configuration example of a cellular telephone to which the present invention has been applied.

FIG. 29 is a block diagram illustrating a primary configuration example of a hard disk recorder to which the present invention has been applied.

FIG. 30 is a block diagram illustrating a primary configuration example of a camera to which the present invention has been applied.

### DESCRIPTION OF EMBODIMENTS

Embodiments of the present invention will be described, with reference to the drawings.

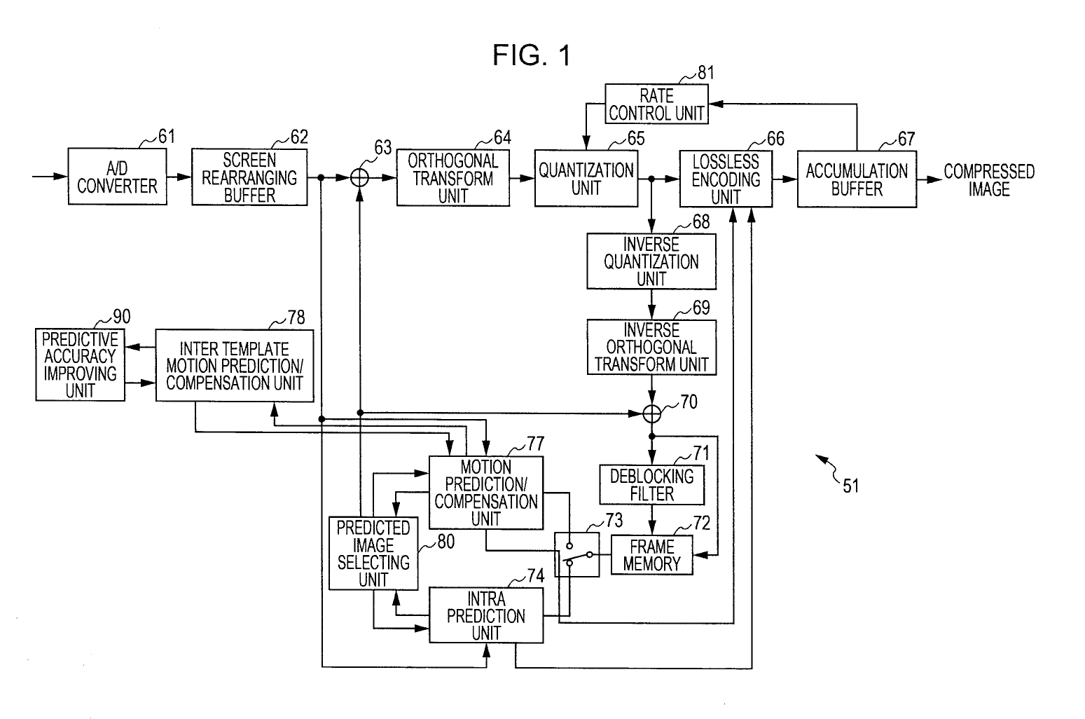

FIG. 1 illustrates the configuration of an embodiment of an image encoding device according to the present invention. This image encoding device 51 includes an A/D converter 61, a screen rearranging buffer 62, a computing unit 63, an orthogonal transform unit 64, a quantization unit 65, a lossless encoding unit 66, an accumulation buffer 67, an inverse quantization unit 68, an inverse orthogonal transform unit 69, a computing unit 70, a deblocking filter 71, a frame memory 72, a switch 73, an intra prediction unit 74, a motion prediction/compensation unit 77, an inter template motion prediction/compensation unit 78, a prediction image selecting unit 80, a rate control unit 81, and a predictive accuracy improving unit 90.

Note that in the following, the inter template motion prediction/compensation unit 78 will be called inter TP motion prediction/compensation unit 78.

This image encoding device 51 performs compression encoding of images with H.264 and MPEG-4 Part 10 (Advanced Video Coding) (hereinafter referred to as H.264/AVC).

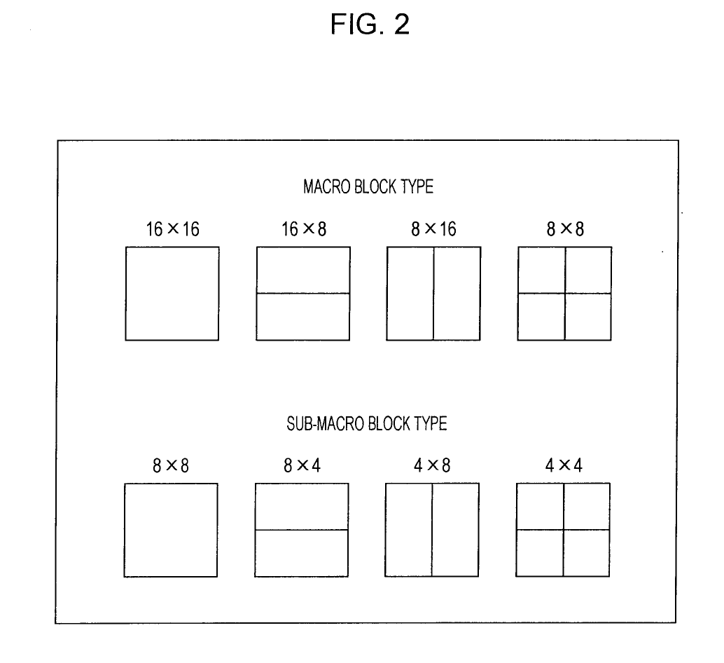

With the H.264/AVC format, motion prediction/compensation processing is performed with variable block sizes. That is to say, with the H.264/AVC format, a macro block configured of 16×16 pixels can be divided into partitions of any one of 16×16 pixels, 16×8 pixels, 8×16 pixels, or 8×8 pixels, with each having independent motion vector information, as shown in FIG. 2. Also, a partition of 8×8 pixels can be divided into sub-partitions of any one of 8×8 pixels, 8×4 pixels, 4×8 pixels, or 4×4 pixels, with each having independent motion vector information, as shown in FIG. 2.

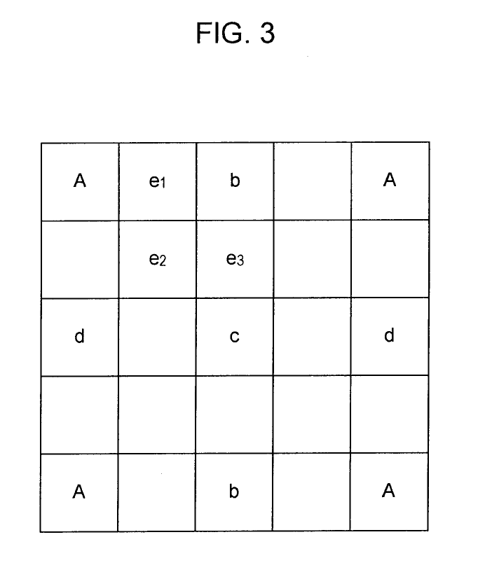

Also, with the H.264/AVC format, quarter-pixel precision prediction/compensation processing is performed using 6-tap FIR (Finite Impulse Response Filter) filter. Sub-pixel precision prediction/compensation processing in the H.264/AVC format will be described with reference to FIG. 3.

In the example in FIG. 3, a position A indicates integer-precision pixel positions, positions b, c, and d indicate half-pixel precision positions, and positions e1, e2, and e3 indicate quarter-pixel precision positions. First, in the following Clip( ) is defined as in the following Expression (1).

$$\begin{matrix}[ Mathematical Expression 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

Note that in the event that the input image is of 8-bit precision, the value of max_pix is 255.

The pixel values at positions b and d are generated as with the following Expression (2), using a 6-tap FIR filter.

[Mathematical Expression 2]

F=A₋₂−5·A₋₁+20·A₀+20·A₁−5·A₂+A₃b,d=Clip1((F+16)>>5) (2)

The pixel value at the position c is generated as with the following Expression (3), using a 6-tap FIR filter in the horizontal direction and vertical direction.

[Mathematical Expression 3]

F=b₋₂−5·b₋₁+20·b₀+20·b₁−5·b₂+b₃

or

F=d₋₂−5·d₋₁+20·d₀+20·d₁−5·d₂+d₃c=Clip1((F+512)>>10) (3)

Note that Clip processing is performed just once at the end, following having performed product-sum processing in both the horizontal direction and vertical direction.

The positions e1 through e3 are generated by linear interpolation as with the following Expression (4).

[Mathematical Expression 4]

e₁=(A+b+1)>>1

e₂=(b+d+1)>>1

e₃=(b+c+1)>>1 (4)

Returning to FIG. 1, the A/D converter 61 performs A/D conversion of input images, and outputs to the screen rearranging buffer 62 so as to be stored. The screen rearranging buffer 62 rearranges the images of frames which are in the order of display stored, in the order of frames for encoding in accordance with the GOP (Group of Picture).

The computing unit 63 subtracts a predicted image from the intra prediction unit 74 or a predicted image from the motion prediction/compensation unit 77, selected by the prediction image selecting unit 80, from the image read out from the screen rearranging buffer 62, and outputs the difference information thereof to the orthogonal transform unit 64. The orthogonal transform unit 64 performs orthogonal transform such as disperse cosine transform, Karhunen-Loëve transform, or the like, on the difference information from the computing unit 63, and outputs transform coefficients thereof. The quantization unit 65 quantizes the transform coefficients which the orthogonal transform unit 64 outputs.

The quantized transform coefficients which are output from the quantization unit 65 are input to the lossless encoding unit 66 where they are subjected to lossless encoding such as variable-length encoding, arithmetic encoding, or the like, and compressed. Note that compressed images are accumulated in the accumulation buffer 67 and then output. The rate control unit 81 controls the quantization operations of the quantization unit 65 based on the compressed images accumulated in the accumulation buffer 67.

Also, the quantized transform coefficients output from the quantization unit 65 are also input to the inverse quantization unit 68 and inverse-quantized, and subjected to inverse orthogonal transform at the inverse orthogonal transform unit 69. The output that has been subjected to inverse orthogonal transform is added with a predicted image supplied from the prediction image selecting unit 80 by the computing unit 70, and becomes a locally-decoded image. The deblocking filter 71 removes block noise in the decoded image, which is then supplied to the frame memory 72, and accumulated. The frame memory 72 also receives supply of the image before the deblocking filter processing by the deblocking filter 71, which is accumulated.

The switch 73 outputs a reference image accumulated in the frame memory 72 to the motion prediction/compensation unit 77 or the intra prediction unit 74.

With the image encoding device 51, for example, an I picture, B pictures, and P pictures, from the screen rearranging buffer 62, are supplied to the intra prediction unit 74 as images for intra-prediction (also called intra processing). Also, B pictures and P pictures read out from the screen rearranging buffer 62 are supplied to the motion prediction/compensation unit 77 as images for inter prediction (also called inter processing).

The intra prediction unit 74 performs intra prediction processing for all candidate intra prediction modes, based on images for intra prediction read out from the screen rearranging buffer 62 and the reference image supplied from the frame memory 72 via the switch 73, and generates a predicted image.

The intra prediction unit 74 calculates a cost function value for all candidate intra prediction modes. The intra prediction unit 74 determines the prediction mode which gives the smallest value of the calculated cost function values to be an optimal intra prediction mode.

The intra prediction unit 74 supplies the predicted image generated in the optimal intra prediction mode and the cost function value thereof to the prediction image selecting unit 80. In the event that the predicted image generated in the optimal intra prediction mode is selected by the prediction image selecting unit 80, the intra prediction unit 74 supplies information relating to the optimal intra prediction mode to the lossless encoding unit 66. The lossless encoding unit 66 encodes this information so as to be a part of the header information in the compressed image.

The motion prediction/compensation unit 77 performs motion prediction/compensation processing for all candidate inter prediction modes. That is to say, the motion prediction/compensation unit 77 detects motion vectors for all candidate inter prediction modes based on the images for inter prediction read out from the screen rearranging buffer 62, and the reference image supplied from the frame memory 72 via the switch 73, subjects the reference image to motion prediction and compensation processing based on the motion vectors, and generates a predicted image.

Also, the motion prediction/compensation unit 77 supplies the images for inter prediction read out from the screen rearranging buffer 62, and the reference image supplied from the frame memory 72 via the switch 73 to the inter TP motion prediction/compensation unit 78.

The motion prediction/compensation unit 77 calculates cost function values for all candidate inter prediction modes. The motion prediction/compensation unit 77 determines the prediction mode which gives the smallest value of the calculated cost function values as to the inter prediction modes and the cost function values for the inter template prediction modes calculated by the inter TP motion prediction/compensation unit 78, to be an optimal inter prediction mode.

The motion prediction/compensation unit 77 supplies the predicted image generated by the optimal inter prediction mode, and the cost function values thereof, to the prediction image selecting unit 80. In the event that the predicted image generated in the optimal inter prediction mode is selected by the prediction image selecting unit 80, the motion prediction/compensation unit 77 outputs the information relating to the optimal inter prediction mode and information corresponding to the optimal inter prediction mode (motion vector information, reference frame information, etc.) to the lossless encoding unit 66. The lossless encoding unit 66 subjects also the information from the motion prediction/compensation unit 77 to lossless encoding such as variable-length encoding, arithmetic encoding, or the like, and inserts this to the header portion of the compressed image.

The inter TP motion prediction/compensation unit 78 performs motion prediction and compensation processing in the inter template prediction mode, based on images for inter prediction read out from the screen rearranging buffer 62, and the reference image supplied from the frame memory 72, and generates a predicted image. At this time, the inter TP motion prediction/compensation unit 78 performs motion prediction in a predetermined search range, which will be described later.

At this time, improvement in motion predictive accuracy is arranged to be realized by the predictive accuracy improving unit 90. Specifically, the predictive accuracy improving unit 90 is configured to determine the maximum likelihood motion vector of motion vectors searched by motion prediction in the inter template prediction mode. Note that the details of the processing of the predictive accuracy improving unit 90 will be described later.

The motion vector information determined by the predictive accuracy improving unit 90 is taken as motion vector information searched by motion prediction in the inter template prediction mode (hereafter, also referred to as inter motion vector information as appropriate).

Also, the inter TP motion prediction/compensation unit 78 calculates cost function values as to the inter template prediction mode, and supplies the calculated cost function values and predicted image to the motion prediction/compensation unit 77.

The prediction image selecting unit 80 determines the optimal prediction mode from the optimal intra prediction mode and optimal inter prediction mode, based on the cost function values output from the intra prediction unit 74 or motion prediction/compensation unit 77, selects the predicted image of the optimal prediction mode that has been determined, and supplies this to the computing units 63 and 70. At this time, the prediction image selecting unit 80 supplies the selection information of the predicted image to the intra prediction unit 74 or motion prediction/compensation unit 77.

The rate control unit 81 controls the rate of quantization operations of the quantization unit 65 so that overflow or underflow does not occur, based on the compressed images accumulated in the accumulation buffer 67.

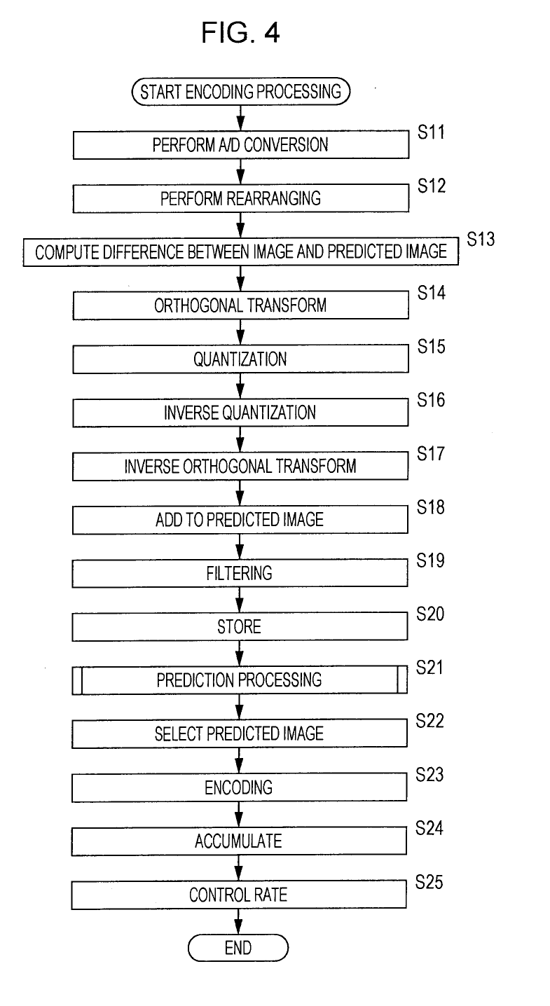

Next, the encoding processing of the image encoding device 51 in FIG. 1 will be described with reference to the flowchart in FIG. 4.

In step S11, the A/D converter 61 performs A/D conversion of an input image. In step S12, the screen rearranging buffer 62 stores the image supplied from the A/D converter 61, and performs rearranging of the pictures from the display order to the encoding order.

In step S13, the computing unit 63 computes the difference between the image rearranged in step S12 and a prediction image. The prediction image is supplied from the motion prediction/compensation unit 77 in the case of performing inter prediction, and from the intra prediction unit 74 in the case of performing intra prediction, to the computing unit 63 via the prediction image selecting unit 80.

The amount of data of the difference data is smaller in comparison to that of the original image data. Accordingly, the data amount can be compressed as compared to a case of performing encoding of the image as it is.

In step S14, the orthogonal transform unit 64 performs orthogonal transform of the difference information supplied from the computing unit 63. Specifically, orthogonal transform such as disperse cosine transform, Karhunen-Loëve transform, or the like, is performed, and transform coefficients are output. In step S15, the quantization unit 65 performs quantization of the transform coefficients. The rate is controlled for this quantization, as described with the processing in step S25 described later.

The difference information quantized as described above is locally decoded as follows. That is to say, in step S16, the inverse quantization unit 68 performs inverse quantization of the transform coefficients quantized by the quantization unit 65, with properties corresponding to the properties of the quantization unit 65. In step S17, the inverse orthogonal transform unit 69 performs inverse orthogonal transform of the transform coefficients subjected to inverse quantization at the inverse quantization unit 68, with properties corresponding to the properties of the orthogonal transform unit 64.

In step S18, the computing unit 70 adds the predicted image input via the prediction image selecting unit 80 to the locally decoded difference information, and generates a locally decoded image (image corresponding to the input to the computing unit 63). In step S19, the deblocking filter 71 performs filtering of the image output from the computing unit 70. Accordingly, block noise is removed. In step S20, the frame memory 72 stores the filtered image. Note that the image not subjected to filter processing by the deblocking filter 71 is also supplied to the frame memory 72 from the computing unit 70, and stored.

In step S21, the intra prediction unit 74, motion prediction/compensation unit 77, and inter TP motion prediction/compensation unit 78 perform their respective image prediction processing. That is to say, in step S21, the intra prediction unit 74 performs intra prediction processing in the intra prediction mode, the motion prediction/compensation unit 77 performs motion prediction/compensation processing in the inter prediction mode, and the inter TP motion prediction/compensation unit 78 performs motion prediction/compensation processing in the inter template prediction mode.

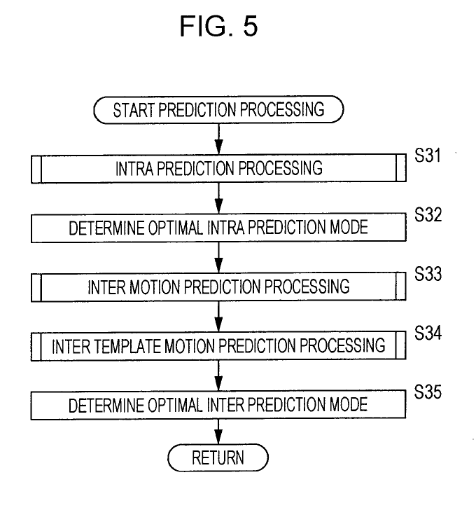

While the details of the prediction processing in step S21 will be described later in detail with reference to FIG. 5, with this processing, prediction processing is performed in each of all candidate prediction modes, and cost function values are each calculated in all candidate prediction modes. An optimal intra prediction mode is selected based on the calculated cost function value, and the predicted image generated by the intra prediction in the optimal intra prediction mode and the cost function value are supplied to the prediction image selecting unit 80. Also, an optimal inter prediction mode is determined from the inter prediction mode and inter template prediction mode based on the calculated cost function value, and the predicted image generated with the optimal inter prediction mode and the cost function value thereof are supplied to the prediction image selecting unit 80.

In step S22, the prediction image selecting unit 80 determines one of the optimal intra prediction mode and optimal inter prediction mode as the optimal prediction mode, based on the respective cost function values output from the intra prediction unit 74 and the motion prediction/compensation unit 77, selects the predicted image of the determined optimal prediction mode, and supplies this to the computing units 63 and 70. The predicted image is used for computation in steps S13 and S18, as described above.

Note that the selection information of the predicted image is supplied to the intra prediction unit 74 or motion prediction/compensation unit 77. In the event that the predicted image of the optimal intra prediction mode is selected, the intra prediction unit 74 supplies information relating to the optimal intra prediction mode to the lossless encoding unit 66.

In the event that the predicted image of the optimal inter prediction mode is selected, the motion prediction/compensation unit 77 outputs information relating to the optimal inter prediction mode, and information corresponding to the optimal inter prediction mode (motion vector information, reference frame information, etc.), to the lossless encoding unit 66. That is to say, in the event that the predicted image with the inter prediction mode is selected as the optimal inter prediction mode, the motion prediction/compensation unit 77 outputs inter prediction mode information, motion vector information, and reference frame information to the lossless encoding unit 66. On the other hand, in the event that an prediction image with the inter template prediction mode is selected, the motion prediction/compensation unit 77 outputs inter template prediction mode information to the lossless encoding unit 66.

In step S23, the lossless encoding unit 66 encodes the quantized transform coefficients output from the quantization unit 65. That is to say, the difference image is subjected to lossless encoding such as variable-length encoding, arithmetic encoding, or the like, and compressed. At this time, the information relating to the optimal intra prediction mode from the intra prediction unit 74 input to the lossless encoding unit 66 in step S22 described above, the information according to the optimal inter prediction mode from the motion prediction/compensation unit 77 (prediction mode information, motion vector information, reference frame information, etc.) and so forth also is encoded and added to the header information.

In step S24, the accumulation buffer 67 accumulates the difference image as a compressed image. The compressed image accumulated in the accumulation buffer 67 is read out as appropriate, and transmitted to the decoding side via the transmission path.

In step S25, the rate control unit 81 controls the rate of quantization operations of the quantization unit 65 so that overflow or underflow does not occur, based on the compressed images accumulated in the accumulation buffer 67.

Next, the prediction processing in step S21 of FIG. 4 will be described with reference to the flowchart in FIG. 5.

In the event that the image to be processed that is supplied from the screen rearranging buffer 62 is a block image for intra processing, a decoded image to be referenced is read out from the frame memory 72, and supplied to the intra prediction unit 74 via the switch 73. Based on these images, in step S31 the intra prediction unit 74 performs intra prediction of pixels of the block to be processed for all candidate intra prediction modes. Note that for decoded pixels to be referenced, pixels not subjected to deblocking filtering by the deblocking filter 71 are used.

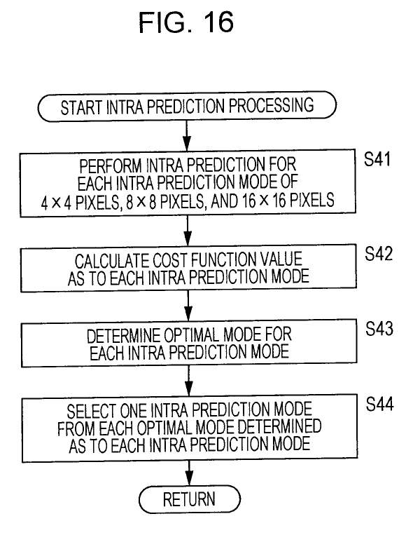

While the details of the intra prediction processing in step S31 will be described later with reference to FIG. 16, due to this processing intra prediction is performed in all candidate intra prediction modes, and cost function values are calculated for all candidate intra prediction modes.

In step S32, the intra prediction unit 74 compares the cost function values calculated in step S31 as to all intra prediction modes which are candidates, and determines the prediction mode which yields the smallest value as the optimal intra prediction mode. The intra prediction unit 74 supplies the predicted image generated in the optimal intra prediction mode and the cost function value thereof to the prediction image selecting unit 80.

In the event that the image to be processed that is supplied from the screen rearranging buffer 62 is an image for inter processing, the image to be referenced is read out from the frame memory 72, and supplied to the motion prediction/compensation unit 77 via the switch 73. In step S33, the motion prediction/compensation unit 77 performs inter motion prediction processing based on these image. That is to say, the motion prediction/compensation unit 77 perform motion prediction processing of all candidate inter prediction modes, with reference to the images supplied from the frame memory 72.

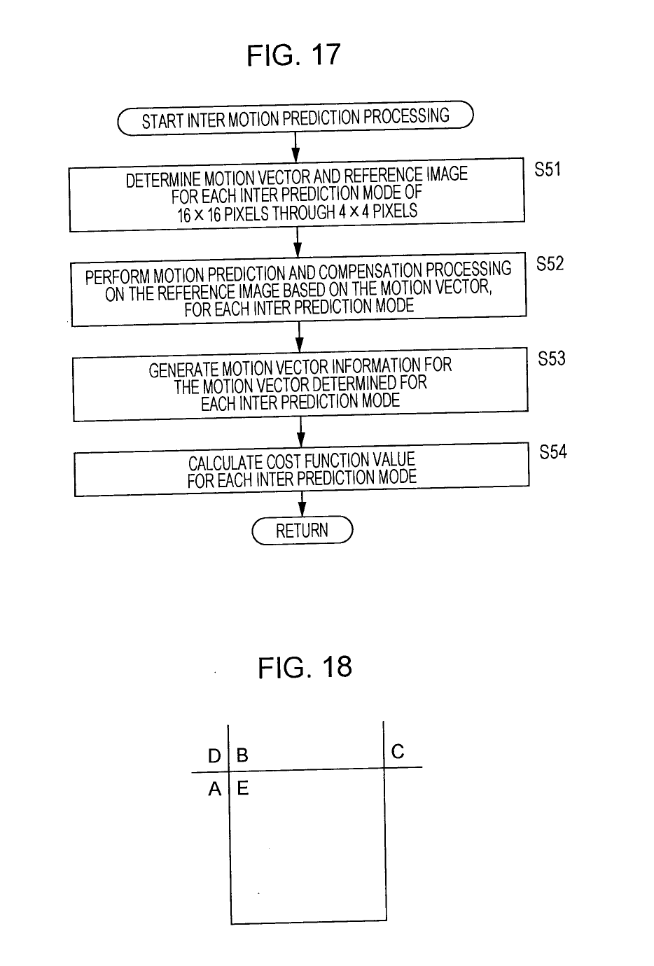

Details of the inter motion prediction processing in step S33 will be described later with reference to FIG. 17, with motion prediction processing being performed in all candidate inter prediction modes and cost function values being calculated for all candidate inter prediction modes by this processing.

Further, in the event that the image to be processed that is supplied from the screen rearranging buffer 62 is an image for inter processing, the image to be referenced that has been read out from the frame memory 72 is supplied to the inter TP motion prediction/compensation unit 78 as well, via the switch 73 and the motion prediction/compensation unit 77. Based on these images, the inter TP motion prediction/compensation unit 78 and the predictive accuracy improving unit 90 perform inter template motion prediction processing in the inter template prediction mode in step S34.

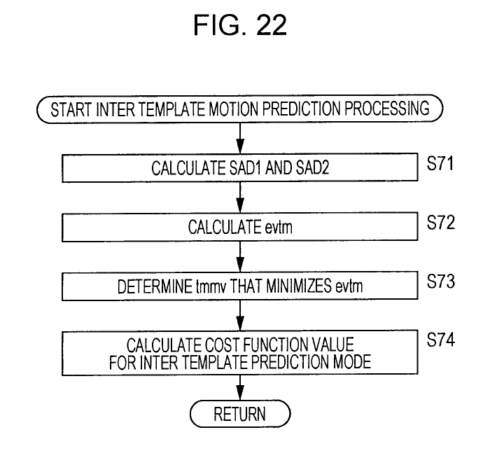

While details of the inter template motion prediction processing in step S34 will be described later with reference to FIG. 22, due to this processing, motion prediction processing is performed in the inter template prediction mode, and cost function values as to the inter template prediction mode are calculated. The predicted image generated by the motion prediction processing in the inter template prediction mode and the cost function value thereof are supplied to the motion prediction/compensation unit 77.

In step S35, the motion prediction/compensation unit 77 compares the cost function value as to the optimal inter prediction mode selected in step S33 with the cost function value calculated as to the inter template prediction mode in step S34, and determines the prediction mode which gives the smallest value to be the optimal inter prediction mode. The motion prediction/compensation unit 77 then supplies the predicted image generated in the optimal inter prediction mode and the cost function value thereof to the prediction image selecting unit 80.

Next, the modes for intra prediction that are stipulated in the H.264/AVC format will be described.

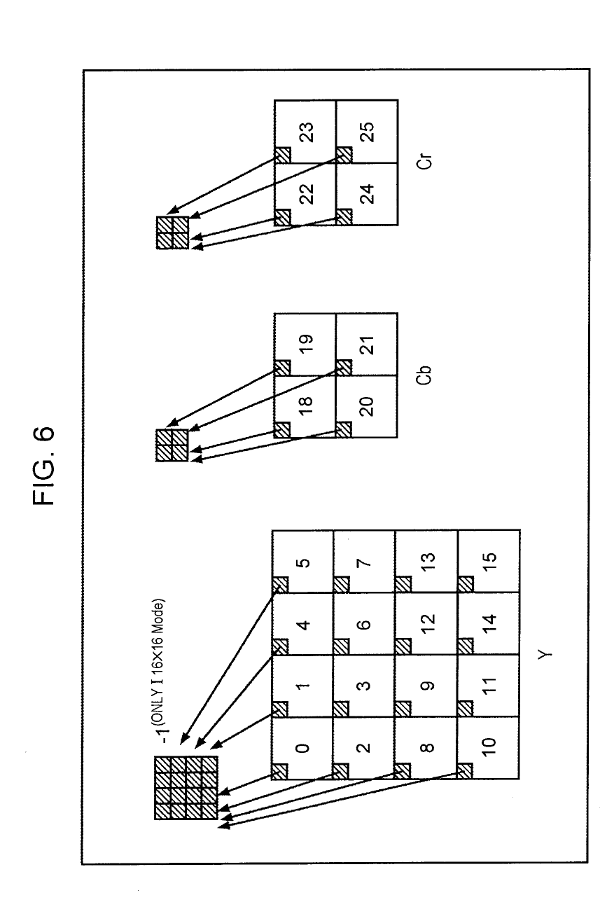

First, the intra prediction modes as to luminance signals will be described. The luminance signal intra prediction mode includes nine types of prediction modes in block increments of 4×4 pixels, and four types of prediction modes in macro block increments of 16×16 pixels. As shown in FIG. 6, in the case of the intra prediction mode of 16×16 pixels, the direct current components of each block are gathered and a 4×4 matrix is generated, and this is further subjected to orthogonal transform.

As for High Profile, a prediction mode in 8×8 pixel block increments is stipulated as to 8'th order DCT blocks, this method being pursuant to the 4×4 pixel intra prediction mode method described next.

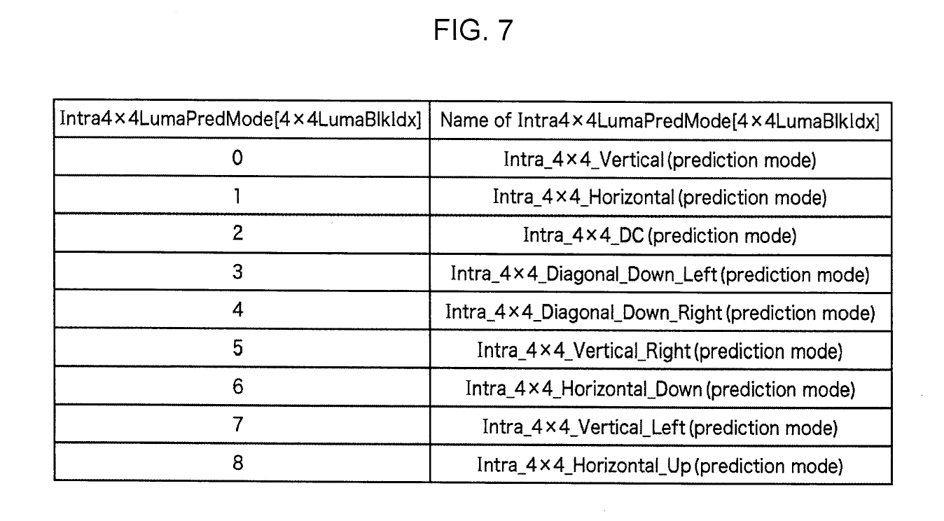

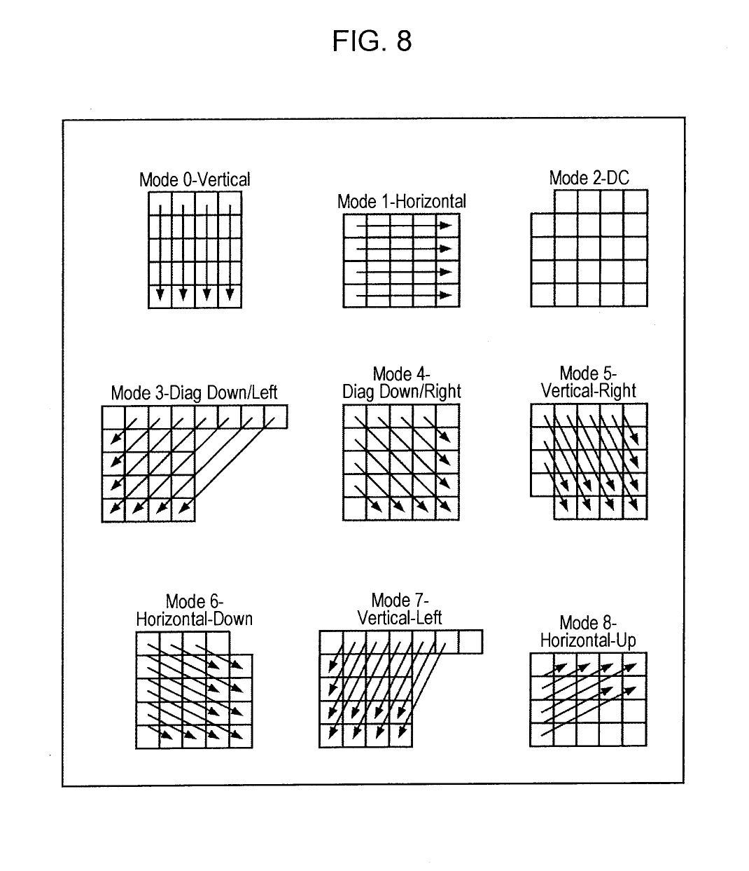

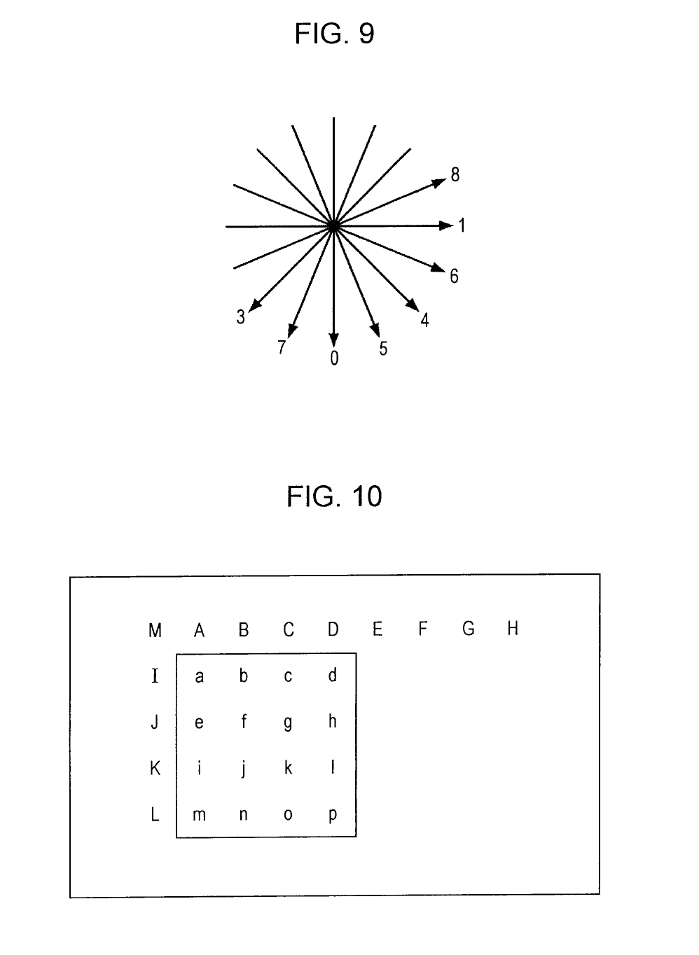

FIG. 7 and FIG. 8 are diagrams illustrating the nine types of luminance signal 4×4 pixel intra prediction modes (Intra_{—}4×4_pred_mode). The eight types of modes other than mode 2 which indicates average value (DC) prediction are each corresponding to the directions indicated by 0, 1, and 3 through 8, in FIG. 9.

The nine types of Intra_{—}4×4_pred_mode will be described with reference to FIG. 10. In the example in FIG. 10, the pixels a through p represent the pixels of the object blocks to be subjected to intra processing, and the pixel values A through M represent the pixel values of pixels belonging to adjacent blocks. That is to say, the pixels a through p are the image to be processed that has been read out from the screen rearranging buffer 62, and the pixel values A through M are pixels values of the decoded image to be referenced that has been read out from the frame memory 72.

In the event of each intra prediction mode in FIG. 7 and FIG. 8, the predicted pixel values of pixels a through p are generated as follows using the pixel values A through M of pixels belonging to adjacent blocks. Note that in the event that the pixel value is “available”, this represents that the pixel is available with no reason such as being at the edge of the image frame or being still unencoded, and in the event that the pixel value is “unavailable”, this represents that the pixel is unavailable due to a reason such as being at the edge of the image frame or being still unencoded.

Mode 0 is a Vertical Prediction mode, and is applied only in the event that pixel values A through D are “available”. In this case, the prediction values of pixels a through p are generated as in the following Expression (5).

Prediction pixel value of pixels a,e,i,m=A

Prediction pixel value of pixels b,f,j,n=B

Prediction pixel value of pixels c,g,k,o=C

Prediction pixel value of pixels d,h,l,p=D (5)

Mode 1 is a Horizontal Prediction mode, and is applied only in the event that pixel values I through L are “available”. In this case, the prediction values of pixels a through p are generated as in the following Expression (6).

Prediction pixel value of pixels a,b,c,d=I

Prediction pixel value of pixels e,f,g,h=J

Prediction pixel value of pixels i,j,k,l=K

Prediction pixel value of pixels m,n,o,p=L (6)

Mode 2 is a DC Prediction mode, and prediction pixel values are generated as in the Expression (7) in the event that pixel values A, B, C, D, I, J, K, L are all “available”.

(A+B+C+D+I+J+K+L+4)>>3 (7)

Also, prediction pixel values are generated as in the Expression (8) in the event that pixel values A, B, C, D are all “unavailable”.

(I+J+K+L+2)>>2 (8)

Also, prediction pixel values are generated as in the Expression (9) in the event that pixel values I, J, K, L are all “unavailable”.

(A+B+C+D+2)>>2 (9)

Also, in the event that pixel values A, B, C, D, I, J, K, L are all “unavailable”, 128 is generated as a prediction pixel value.

Mode 3 is a Diagonal_Down_Left Prediction mode, and is applied only in the event that pixel values A, B, C, D, I, J, K, L, M are “available”. In this case, the prediction pixel values of the pixels a through p are generated as in the following Expression (10).

Prediction pixel value of pixel a=(A+2B+C+2)>>2

Prediction pixel values of pixels b,e=(B+2C+D+2)>>2

Prediction pixel values of pixels c,f,i=(C+2D+E+2)>>2

Prediction pixel values of pixels d,g,j,m=(D+2E+F+2)>>2

Prediction pixel values of pixels h,k,n=(E+2F+G+2)>>2

Prediction pixel values of pixels l,o=(F+2G+H+2)>>2

Prediction pixel value of pixel p=(G+3H+2)>>2 (10)

Mode 4 is a Diagonal_Down_Right Prediction mode, and is applied only in the event that pixel values A, B, C, D, I, J, K, L, M are “available”. In this case, the prediction pixel values of the pixels a through p are generated as in the following Expression (11).

Prediction pixel value of pixel m=(J+2K+L+2)>>2

Prediction pixel values of pixels i,n=(I+2J+K+2)>>2

Prediction pixel values of pixels e,j,o=(M+2I+J+2)>>2

Prediction pixel values of pixels a,f,k,p=(A+2M+I+2)>>2

Prediction pixel values of pixels b,g,l=(M+2A+B+2)>>2

Prediction pixel values of pixels c,h=(A+2B+C+2)>>2

Prediction pixel value of pixel d=(B+2C+D+2)>>2 (11)

Mode 5 is a Diagonal_Vertical_Right Prediction mode, and is applied only in the event that pixel values A, B, C, D, I, J, K, L, M are “available”. In this case, the prediction pixel values of the pixels a through p are generated as in the following Expression (12).

Prediction pixel value of pixels a,j=(M+A+1)>>1

Prediction pixel value of pixels b,k=(A+B+1)>>1

Prediction pixel value of pixels c,l=(B+C+1)>>1

Prediction pixel value of pixel d=(C+D+1)>>1

Prediction pixel value of pixels e,n=(I+2M+A+2)>>2

Prediction pixel value of pixels f,o=(M+2A+B+2)>>2

Prediction pixel value of pixels g,p=(A+2B+C+2)>>2

Prediction pixel value of pixel h=(B+2C+D+2)>>2

Prediction pixel value of pixel i=(M+2I+J+2)>>2

Prediction pixel value of pixel m=(I+2J+K+2)>>2 (12)

Mode 6 is a Horizontal_Down Prediction mode, and is applied only in the event that pixel values A, B, C, D, I, J, K, L, M are “available”. In this case, the prediction pixel values of the pixels a through p are generated as in the following Expression (13).

Prediction pixel values of pixels a,g=(M+I+1)>>1

Prediction pixel values of pixels b,h=(I+2M+A+2)>>2

Prediction pixel value of pixel c=(M+2A+B+2)>>2

Prediction pixel value of pixel d=(A+2B+C+2)>>2

Prediction pixel values of pixels e,k=(I+J+1)>>1

Prediction pixel values of pixels f,l=(M+2I+J+2)>>2

Prediction pixel values of pixels i,o=(J+K+1)>>1

Prediction pixel values of pixels j,p=(I+2J+K+2)>>2

Prediction pixel value of pixel m=(K+L+1)>>1

Prediction pixel value of pixel n=(J+2K+L+2)>>2 (13)

Mode 7 is a Vertical Left Prediction mode, and is applied only in the event that pixel values A, B, C, D, I, J, K, L, M are “available”. In this case, the prediction pixel values of the pixels a through p are generated as in the following Expression (14).

Prediction pixel value of pixel a=(A+B+1)>>1

Prediction pixel values of pixels b,i=(B+C+1)>>1

Prediction pixel values of pixels c,j=(C+D+1)>>1

Prediction pixel values of pixels d,k=(D+E+1)>>1

Prediction pixel value of pixel l=(E+F+1)>>1

Prediction pixel value of pixel e=(A+2B+C+2)>>2

Prediction pixel values of pixels f,m=(B+2C+D+2)>>2

Prediction pixel values of pixels g,n=(C+2D+E+2)>>2

Prediction pixel values of pixels h,o=(D+2E+F+2)>>2

Prediction pixel value of pixel p=(E+2F+G+2)>>2 (14)

Mode 8 is a Horizontal_Up Prediction mode, and is applied only in the event that pixel values A, B, C, D, I, J, K, L, M are “available”. In this case, the prediction pixel values of the pixels a through p are generated as in the following Expression (15).

Prediction pixel value of pixel a=(I+J+1)>>1

Prediction pixel value of pixels b=(I+2J+K+2)>>2

Prediction pixel values of pixels c,e=(J+K+1)>>1

Prediction pixel values of pixels d,f=(J+2K+L+2)>>2

Prediction pixel values of pixels g,i=(K+L+1)>>1

Prediction pixel values of pixels h,j=(K+3L+2)>>2

Prediction pixel values of pixels k,l,m,n,o,p=L (15)

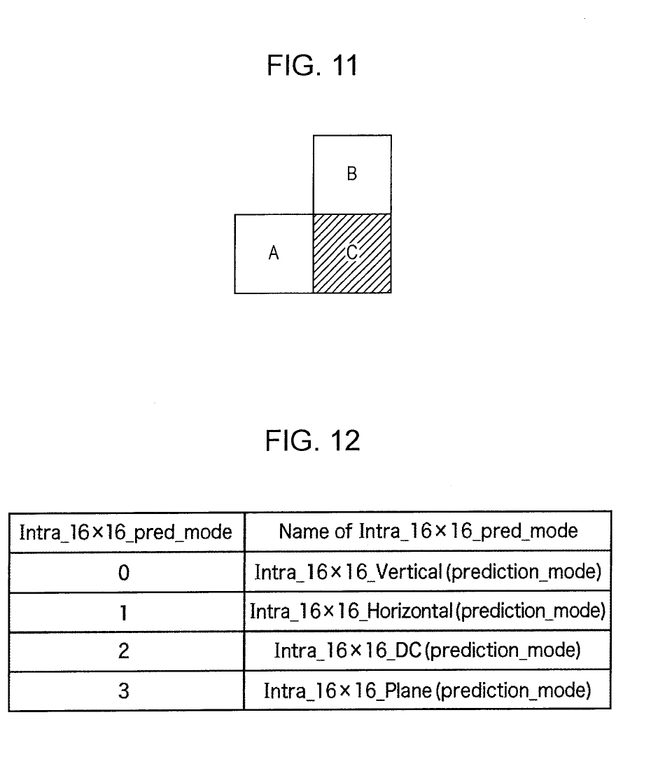

Next, the intra prediction mode (Intra_{—}4×4_pred_mode) encoding method for 4×4 pixel luminance signals will be described with reference to FIG. 11.

In the example in FIG. 11, an object block C to be encoded which is made up of 4×4 pixels is shown, and a block A and block B which are made up of 4×4 pixel and are adjacent to the object block C are shown.

In this case, the Intra_{—}4×4_pred_mode in the object block C and the Intra_{—}4×4_pred_mode in the block A and block B are thought to have high correlation. Performing the following encoding processing using this correlation allows higher encoding efficiency to be realized.

That is to say, in the example in FIG. 11, with the Intra_{—}4×4_pred_mode in the block A and block B as Intra_{—}4×4_pred_modeA and Intra_{—}4×4_pred_modeB respectively, the MostProbableMode is defined as the following Expression (16).

MostProbableMode=Min(Intra_{—}4×4_pred_modeA,Intra_{—}4×4_pred_modeB) (16)

That is to say, of the block A and block B, that with the smaller mode number allocated thereto is taken as the MostProbableMode.

There are two values of prey_intra4×4_pred_mode_flag[luma4×4BlkIdx] and rem_intra4×4_pred_mode[luma4×4BlkIdx] defined as parameters as to the object block C in the bit stream, with decoding processing being performed by processing based on the pseudocode shown in the following Expression (17), so the values of Intra_{—}4×4_pred_mode, Intra4×4PredMode[luma4×4BlkIdx] as to the object block C can be obtained.

$$if ( prev\_intra4 \times 4 \_pred \_mode \_flag [ luma 4 \times 4 BlkIdx ] ) \\ Intra 4 \times 4 PredMode [ luma 4 \times 4 BlkIdx ] = MostProbableMode \\ else \\ if ( rem\_intra 4 \times 4 \_pred \_mode [ luma 4 \times 4 BlkIdx ] < MostProbableMode ) \\ Intra 4 \times 4 PredMode [ luma 4 \times 4 BlkIdx ] = rem\_intra 4 \times 4 \_pred \_mode [ luma 4 \times 4 BlkIdx ] \\ else \\ Intra 4 \times 4 PredMode [ luma 4 \times 4 BlkIdx ] = rem\_intra 4 \times 4 \_pred \_mode [ luma 4 \times 4 BlkIdx ] + 1 \qquad ( 17 )$$

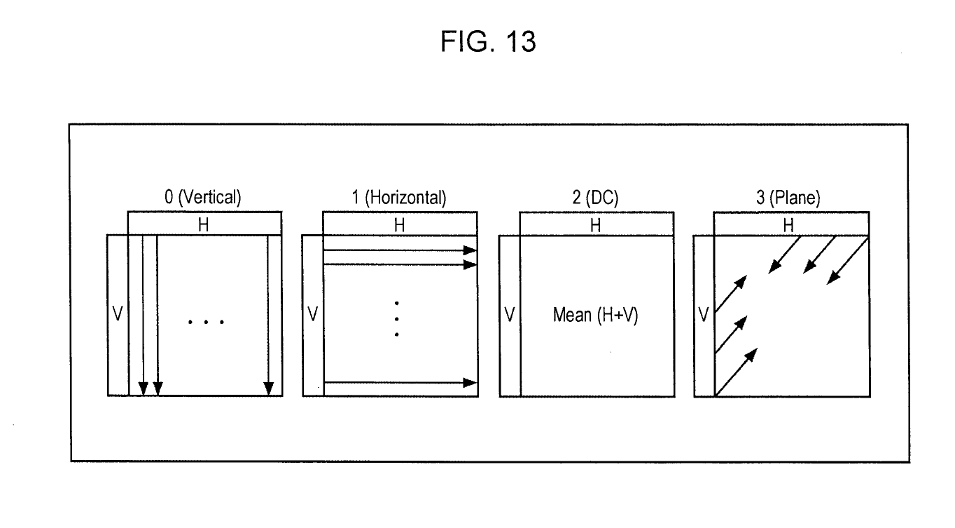

Next, the 16×16 pixel intra prediction mode will be described. FIG. 12 and FIG. 13 are diagrams illustrating the four types of 16×16 pixels luminance signal intra prediction modes (Intra_{—}16×16_pred_mode).

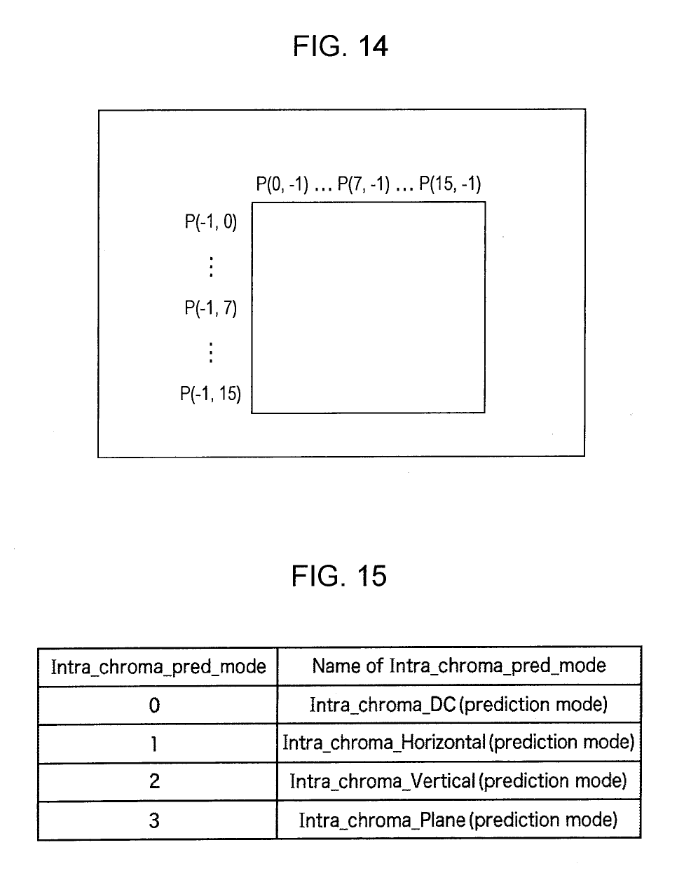

The four types of intra prediction modes will be described with reference to FIG. 14. In the example in FIG. 14, an object macro block A to be subjected to intra processing is shown, and P(x,y); x,y=−1, 0, . . . , 15 represents the pixel values of the pixels adjacent to the object macro block A.

Mode 0 is the Vertical Prediction mode, and is applied only in the event that P(x,−1); x,y=−1, 0, . . . , 15 is “available”. In this case, the prediction pixel value Pred(xylem) of each of the pixels in the object macro block A is generated as in the following Expression (18).

Pred(x,y)=P(x,−1);x,y=0, . . . ,15 (18)

Mode 1 is the Horizontal Prediction mode, and is applied only in the event that P(−1,y); x,y=−1, 0, . . . , 15 is “available”. In this case, the prediction pixel value Pred(xylem) of each of the pixels in the object macro block A is generated as in the following Expression (19).

Pred(x,y)=P(−1,y);x,y=0, . . . ,15 (19)

Mode 2 is the DC Prediction mode, and in the event that P(x,−1) and P(−1,y); x,y=−1, 0, . . . , 15 are all “available”, the prediction pixel value Pred(xylem) of each of the pixels in the object macro block A is generated as in the following Expression (20).

$$\begin{matrix}[ Mathematical Expression 5 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] << 5 \\ with \\ x , y = 0 , … , 15 & ( 20 )\end{matrix}$$

Also, in the event that P(x,−1); x,y=−1, 0, . . . , 15 is “unavailable”, the prediction pixel value Pred(xylem) of each of the pixels in the object macro block A is generated as in the following Expression (21).

$$\begin{matrix}[ Mathematical Expression 6 ] & \\ Pred ( x , y ) = [ {\sum }_{{y}^{′} = 0}^{15} P ( - 1 , {y}^{′} ) + 8 ] >> 4 \\ with \\ x , y = 0 , … , 15 & ( 21 )\end{matrix}$$

In the event that P(−1,y); x,y=−1, 0, . . . , 15 is “unavailable”, the prediction pixel value Pred(xylem) of each of the pixels in the object macro block A is generated as in the following Expression (22).

$$\begin{matrix}[ Mathematical Expression 7 ] & \\ Pred ( x , y ) = [ {\sum }_{{y}^{′} = 0}^{15} P ( {x}^{′} , - 1 ) + 8 ] >> 4 \\ with \\ x , y = 0 , … , 15 & ( 22 )\end{matrix}$$

In the event that P(x,−1) and P(−1,y); x,y=−1, 0, . . . , are all “unavailable”, 128 is used as a prediction pixel value.

Mode 3 is the Plane Prediction mode, and is applied only in the event that P(x,−1 and P(−1,y); x,y=−1, 0, . . . , 15 are all “available”. In this case, the prediction pixel value Pred(xylem) of each of the pixels in the object macro block A is generated as in the following Expression (23).

$$\begin{matrix}[ Mathematical Expression 8 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 23 )\end{matrix}$$

Next, the intra prediction modes as to color difference signals will be described. FIG. 15 is a diagram illustrating the four types of color difference signal intra prediction modes (Intra chroma pred mode). The color difference signal intra prediction mode can be set independently from the luminance signal intra prediction mode. The intra prediction mode for color difference signals conforms to the above-described luminance signal 16×16 pixel intra prediction mode.

Note however, that while the luminance signal 16×16 pixel intra prediction mode handles 16×16 pixel blocks, the intra prediction mode for color difference signals handles 8×8 pixel blocks. Further, the mode Nos. do not correspond between the two, as can be seen in FIG. 12 and FIG. 15 described above.

In accordance with the definition of pixel values of the macro block A which is the object of the luminance signal 16×16 pixel intra prediction mode and the adjacent pixel values described above with reference to FIG. 14, the pixel values adjacent to the macro block A for intra processing (8×8 pixels in the case of color difference signals) will be taken as P(x,y); x,y=−1, 0, . . . , 7.

Mode 0 is the DC Prediction mode, and in the event that P(x,−1) and P(−1,y); x,y=−1, 0, . . . , 7 are all “available”, the prediction pixel value Pred(x,y) of each of the pixels of the object macro block A is generated as in the following Expression (24).

$$\begin{matrix}[ Mathematical Expression 9 ] & \\ Pred ( x , y ) = ( ( {\sum }_{n = 0}^{7} ( P ( - 1 , n ) + P ( n , - 1 ) ) ) + 8 ) >> 4 \\ with \\ x , y = 0 , … , 7 & ( 24 )\end{matrix}$$

Also, in the event that P(−1,y); x,y=−1, 0, . . . , 7 is “unavailable”, the prediction pixel value Pred(x,y) of each of the pixels of object macro block A is generated as in the following Expression (25).

$$\begin{matrix}[ Mathematical Expression 10 ] & \\ Pred ( x , y ) = [ ( {\sum }_{n = 0}^{7} P ( n , - 1 ) ) + 4 ] >> 3 \\ with \\ x , y = 0 , … , 7 & ( 25 )\end{matrix}$$

Also, in the event that P(x,−1); x,y=−1, 0, . . . , 7 is “unavailable”, the prediction pixel value Pred(x,y) of each of the pixels of object macro block A is generated as in the following Expression (26).

$$\begin{matrix}[ Mathematical Expression 11 ] & \\ Pred ( x , y ) = [ ( {\sum }_{n = 0}^{7} P ( - 1 , n ) ) + 4 ] >> 3 \\ with \\ x , y = 0 , … , 7 & ( 26 )\end{matrix}$$

Mode 1 is the Horizontal Prediction mode, and is applied only in the event that P(−1,y); x,y=−1, 0, . . . , 7 is “available”. In this case, the prediction pixel value Pred(x,y) of each of the pixels of object macro block A is generated as in the following Expression (27).

Pred(x,y)=P(−1,y);x,y=0, . . . ,7 (27)

Mode 2 is the Vertical Prediction mode, and is applied only in the event that P(x,−1); x,y=−1, 0, . . . , 7 is “available”. In this case, the prediction pixel value Pred(x,y) of each of the pixels of object macro block A is generated as in the following Expression (28).

Pred(x,y)=P(x,−1);x,y=0, . . . ,7 (28)

Mode 3 is the Plane Prediction mode, and is applied only in the event that P(x,−1) and P(−1,y); x,y=−1, 0, . . . , 7 are “available” In this case, the prediction pixel value Pred(x,y) of each of the pixels of object macro block A is generated as in the following Expression (29).

$$\begin{matrix}[ Mathematical Expression 12 ] & \\ Pred ( x , y ) = Clip 1 ( a + b \cdot ( x - 3 ) + c \cdot ( y - 3 ) + 16 ) >> 5 ; \\ x , y = 0 , … , 7 \\ a = 16 \cdot ( P ( - 1 , 7 ) + P ( 7 , - 1 ) ) \\ b = ( 17 \cdot H + 16 ) >> 5 \\ c = ( 17 \cdot V + 16 ) >> 5 \\ H = {\sum }_{x = 1}^{4} x \cdot [ P ( 3 + x , - 1 ) - P ( 3 - x , - 1 ) ] \\ V = {\sum }_{y = 1}^{4} y \cdot [ P ( - 1 , 3 + y ) - P ( - 1 , 3 - y ) ] & ( 29 )\end{matrix}$$

As described above, there are nine types of 4×4 pixel and 8×8 pixel block-increment and four types of 16×16 pixel macro block-increment prediction modes for luminance signal intra prediction modes, and there are four types of 8×8 pixel block-increment prediction modes for color difference signal intra prediction modes. The color difference intra prediction mode can be set separately from the luminance signal intra prediction mode. For the luminance signal 4×4 pixel and 8×8 pixel intra prediction modes, one intra prediction mode is defined for each 4×4 pixel and 8×8 pixel luminance signal block. For luminance signal 16×16 pixel intra prediction modes and color difference intra prediction modes, one prediction mode is defined for each macro block.

Note that the types of prediction modes correspond to the directions indicated by the Nos. 0, 1, 3 through 8, in FIG. 9 described above. Prediction mode 2 is an average value prediction.

Next, the intra prediction processing in step S31 of FIG. 5, which is processing performed as to these intra prediction modes, will be described with reference to the flowchart in FIG. 16. Note that in the example in FIG. 16, the case of luminance signals will be described as an example.

In step S41, the intra prediction unit 74 performs intra prediction as to each intra prediction mode of 4×4 pixels, 8×8 pixels, and 16×16 pixels, for luminance signals, described above.

For example, the case of 4×4 pixel intra prediction mode will be described with reference to FIG. 10 described above. In the event that the image to be processed that has been read out from the screen rearranging buffer 62 (e.g., pixels a through p), is a block image to be subjected to intra processing, a decoded image to be referenced (pixels indicated by pixel values A through M) is read out from the frame memory 72, and supplied to the intra prediction unit 74 via the switch 73.

Based on these images, the intra prediction unit 74 performs intra prediction of the pixels of the block to be processed. Performing this intra prediction processing in each intra prediction mode results in a prediction image being generated in each intra prediction mode. Note that pixels not subject to deblocking filtering by the deblocking filter 71 are used as the decoded pixels to be referenced (pixels indicated by pixel values A through M).

In step S42, the intra prediction unit 74 calculates cost function values for each intra prediction mode of 4×4 pixels, 8×8 pixels, and 16×16 pixels. Now, one technique of either a High Complexity mode or a Low Complexity mode is used for cost function values, as stipulated in JM (Joint Model) which is reference software in the H.264/AVC format.

That is to say, with the High Complexity mode, as far as temporary encoding processing is performed for all candidate prediction modes as the processing of step S41, a cost function value is calculated for each prediction mode as shown in the following Expression (30), and the prediction mode which yields the smallest value is selected as the optimal prediction mode.

Cost(Mode)=D+λ·R (30)

D is difference (noise) between the original image and decoded image, R is generated code amount including orthogonal transform coefficients, and λ is a Lagrange multiplier given as a function of a quantization parameter QP.

On the other hand, in the Low Complexity mode, as for the processing of step S41, prediction images are generated and calculation is performed as far as the header bits such as motion vector information and prediction mode information, for all candidates prediction modes, a cost function value shown in the following Expression (31) is calculated for each prediction mode, and the prediction mode yielding the smallest value is selected as the optimal prediction mode.

Cost(Mode)=D+QPtoQuant(QP)·Header_Bit (31)

D is difference (noise) between the original image and decoded image, Header_Bit is header bits for the prediction mode, and QPtoQuant is a function given as a function of a quantization parameter QP.

In the Low Complexity mode, just a prediction image is generated for all prediction modes, and there is no need to perform encoding processing and decoding processing, so the amount of computation that has to be performed is small.

In step S43, the intra prediction unit 74 determines an optimal mode for each intra prediction mode of 4×4 pixels, 8×8 pixels, and 16×16 pixels. That is to say, as described above with reference to FIG. 9, there are nine types of prediction modes for intra 4×4 pixel prediction mode and intra 8×8 pixel prediction mode, and there are four types of prediction modes for intra 16×16 pixel prediction mode. Accordingly, the intra prediction unit 74 determines from these an optimal intra 4×4 pixel prediction mode, an optimal intra 8×8 pixel prediction mode, and an optimal intra 16×16 pixel prediction mode, based on the cost function value calculated in step S42.

In step S44, the intra prediction unit 74 selects one intra prediction mode from the optimal modes decided for each intra prediction mode of 4×4 pixels, 8×8 pixels, and 16×16 pixels, based on the cost function value calculated in step S42. That is to say, the intra prediction mode of which the cost function value is the smallest is selected from the optimal modes decided for each of 4×4 pixels, 8×8 pixels, and 16×16 pixels.

Next, the inter motion prediction processing in step S33 in FIG. 5 will be described with reference to the flowchart in FIG. 17.

In step S51, the motion prediction/compensation unit 77 determines a motion vector and reference image for each of the eight types of inter prediction modes made up of 16×16 pixels through 4×4 pixels, described above with reference to FIG. 2. That is to say, a motion vector and reference image are determined for a block to be processed with each inter prediction mode.

In step S52, the motion prediction/compensation unit 77 performs motion prediction and compensation processing for the reference image, based on the motion vector determined in step S51, for each of the eight types of inter prediction modes made up of 16×16 pixels through 4×4 pixels. As a result of this motion prediction and compensation processing, a prediction image is generated in each inter prediction mode.

In step S53, the motion prediction/compensation unit 77 generates motion vector information to be added to a compressed image, based on the motion vector determined as to the eight types of inter prediction modes made up of 16×16 pixels through 4×4 pixels.

Now, a motion vector information generating method with the H.264/AVC format will be described with reference to FIG. 18. The example in FIG. 18 shows an object block E to be encoded from now (e.g., 16×16 pixels), and blocks A through D which have already been encoded and are adjacent to the object block E.

That is to say, the block D is situated adjacent to the upper left of the object block E, the block B is situated adjacent above the object block E, the block C is situated adjacent to the upper right of the object block E, and the block A is situated adjacent to the left of the object block E. Note that the reason why blocks A through D are not sectioned off is to express that they are blocks of one of the configurations of 16×16 pixels through 4×4 pixels, described above with FIG. 2.

For example, let us express motion vector information as to X (=A, B, C, D, E) as mvX. First, prediction motion vector information (prediction value of motion vector) pmvE as to the object block E is generated as shown in the following Expression (32), using motion vector information relating to the blocks A, B, and C.

pmvE=med(mvA,mvB,mvC) (32)

In the event that the motion vector information relating to the block C is not available (is unavailable) due to a reason such as being at the edge of the image frame, or not being encoded yet, the motion vector information relating to the block D is substituted instead of the motion vector information relating to the block C.

Data mvdE to be added to the header portion of the compressed image, as motion vector information as to the object block E, is generated as shown in the following Expression (33), using pmvE.

mvdE=mvE−pmvE (33)

Note that in actual practice, processing is performed independently for each component of the horizontal direction and vertical direction of the motion vector information.

Thus, motion vector information can be reduced by generating prediction motion vector information, and adding the difference between the prediction motion vector information generated from correlation with adjacent blocks and the motion vector information to the header portion of the compressed image.

The motion vector information generated in this way is also used for calculating cost function values in the following step S54, and in the event that a corresponding prediction image is ultimately selected by the prediction image selecting unit 80, this is output to the lossless encoding unit 66 along with the mode information and reference frame information.

Returning to FIG. 17, in step S54 the motion prediction/compensation unit 77 calculates the cost function values shown in Expression (30) or Expression (31) described above, for each inter prediction mode of the eight types of inter prediction modes made up of 16×16 pixels through 4×4 pixels. The cost function values calculated here are used at the time of determining the optimal inter prediction mode in step S35 in FIG. 5 described above.

Note that calculation of the cost function values as to the inter prediction modes includes evaluation of cost function values in Skip Mode and Direct Mode, stipulated in the H.264/AVC format.

Next, the inter template prediction processing in step S34 in FIG. 5 will be described.

First, the inter template matching method will be described. The inter TP motion prediction/compensation unit 78 performs motion vector searching with the inter template matching method.

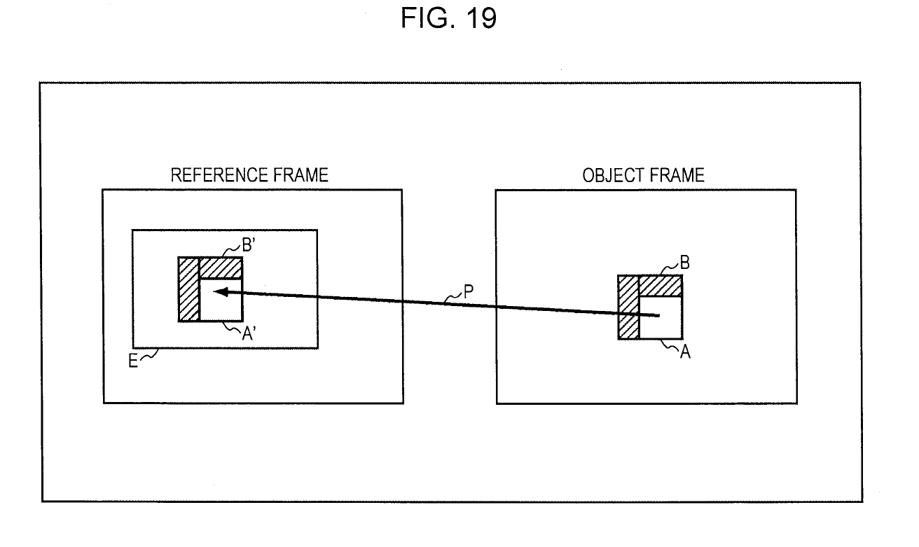

FIG. 19 is a diagram describing the inter template matching method in detail.

In the example in FIG. 19, an object frame to be encoded, and a reference frame referenced at the time of searching for a motion vector, are shown. In the object frame are shown an object block A which is to be encoded from now, and a template region B which is adjacent to the object block A and is made up of already-encoded pixels. That is to say, the template region B is a region to the left and the upper side of the object block A when performing encoding in raster scan order, as shown in FIG. 19, and is a region where the decoded image is accumulated in the frame memory 72.

The inter TP motion prediction/compensation unit 78 performs matching processing with SAD (Sum of Absolute Difference) or the like for example, as the cost function value, within a predetermined search range E on the reference frame, and searches for a region B′ wherein the correlation with the pixel values of the template region B is the highest. The inter TP motion prediction/compensation unit 78 then takes a block A′ corresponding to the found region B′ as a prediction image as to the object block A, and searches for a motion vector P corresponding to the object block A. That is to say, with the inter template matching method, motion vectors in a current block to be encoded are searched and the motion of the current block to be encoded is predicted, by performing matching processing for the template which is an encoded region.

As described here, with the motion vector search processing using the inter template matching method, a decoded image is used for the template matching processing, so the same processing can be performed with the image encoding device 51 in FIG. 1 and a later-described image decoding device by setting a predetermined search range E beforehand. That is to say, with the image decoding device as well, configuring an inter TP motion prediction/compensation unit does away with the need to send motion vector P information regarding the object block A to the image decoding device, so motion vector information in the compressed image can be reduced.

Also note that this predetermined search range E is a search range centered on a motion vector (0, 0), for example. Also, the predetermined search range E may be a search range centered on the predicted motion vector information generated from correlation with an adjacent block as described above with reference to FIG. 18, for example.

Also, the inter template matching method can handle multi-reference frames (Multi-Reference Frame).

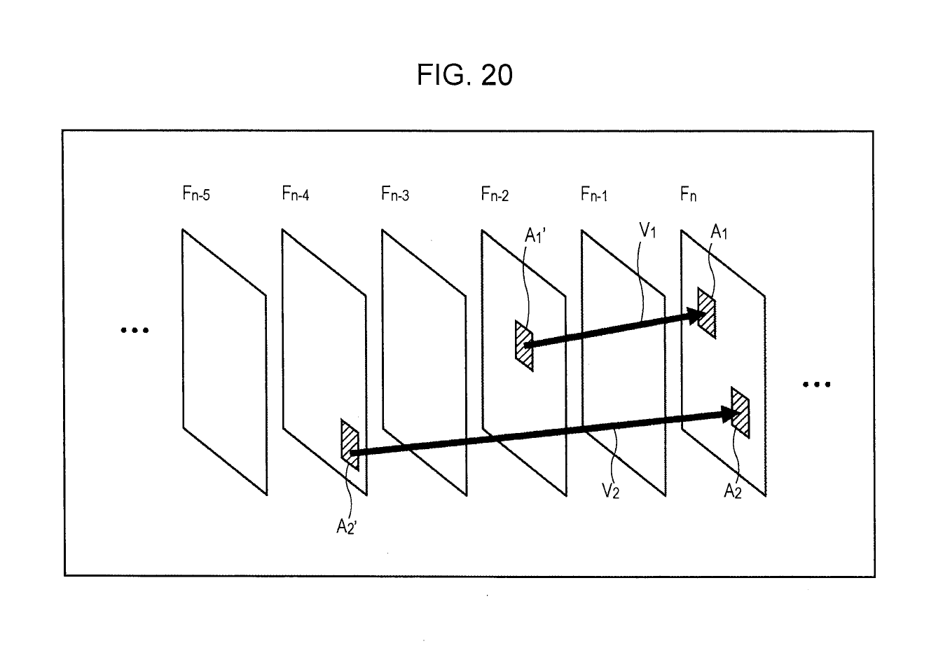

Now, the motion prediction/compensation method of multi-reference frames stipulated in the H.264/AVC format will be described with reference to FIG. 20.

In the example in FIG. 20, an object frame Fn to be encoded from now, and already-encoded frames Fn-5, Fn-1, are shown. The frame Fn-1 is a frame one before the object frame Fn, the frame Fn-2 is a frame two before the object frame Fn, and the frame Fn-3 is a frame three before the object frame Fn. Also, the frame Fn-4 is a frame four before the object frame Fn, and the frame Fn-5 is a frame five before the object frame Fn. The closer the frame is to the object frame, the smaller the index (also called reference frame No.) the frame is. That is to say, the index is smaller in the order of Fn-1, Fn-5.

Block A1 and block A2 are displayed in the object frame Fn, with a motion vector V1 having been found due to the block A1 having correlation with a block A1′ in the frame Fn-2 two back. Also, a motion vector V2 has been found due to the block A2 having correlation with a block A2′ in the frame Fn-4 four back.

That is to say, with MPEG2, the only P picture which could be referenced is the immediately-previous frame Fn-1, but with the H.264/AVC format, multiple reference frames can be held, and reference frame information independent for each block can be had, such as the block A1 referencing the frame Fn-2 and the block A2 referencing the frame Fn-4.

Incidentally, the motion vector P to be searched by the inter template matching method is subjected to matching processing with not an image value included in the object block A serving as an actual object to be encoded but an image value included in the template region B, which leads to a problem wherein predictive accuracy deteriorates.

Therefore, with the present invention, the accuracy of a motion vector to be searched for by the inter template matching method is improved as follows.

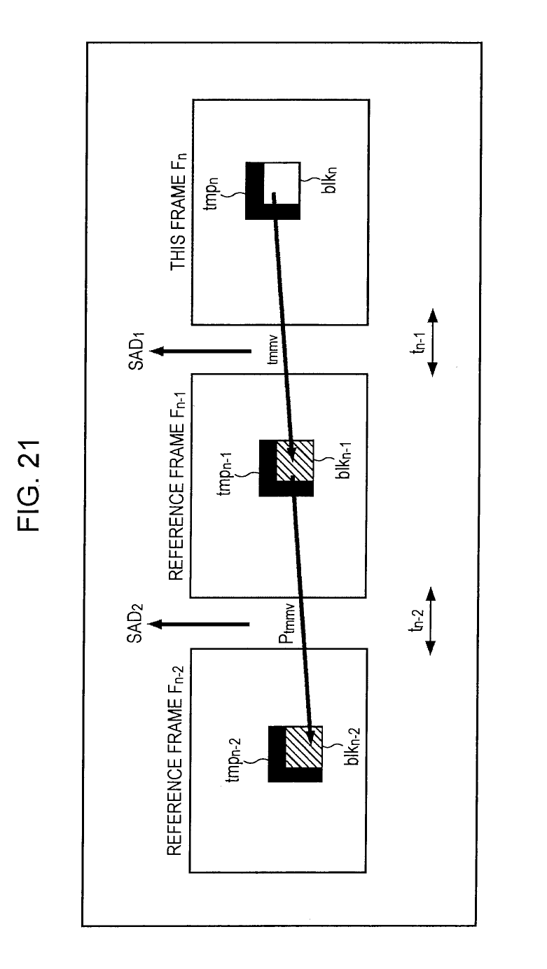

FIG. 21 is a diagram for describing improvement in accuracy of a motion vector to be searched for by the inter template matching method according to the present invention.

In this drawing, let us say that a current block to be encoded in this frame Fn is taken as blkn, and the template region in this frame Fn is taken as tmpn. Similarly, let us say that a block corresponding to the a current block to be encoded in the reference frame Fn-1 is taken as blkn-1, and a region corresponding to a template region in the reference frame Fn-1 is taken as tmpn-1. Also, with the example in this drawing, let us say that a template matching motion vector tmmv is searched in a predetermined range.

First, in the same way as with the case shown in FIG. 19, the matching processing for the template region tmpn, and the region tempn-1 is performed based on SAD (Sum of Absolute Difference). At this time, an SAD value correlated with each of the respective motion vectors tmmv is calculated. Let us say that the SAD value to be calculated herein is taken as SAD1.

With the present invention, a translation model is assumed to realize improvement in predictive accuracy by the predictive accuracy improving unit 90. Specifically, as described above, obtaining the optimal tmmv by matching of the SAD1 alone leads to deterioration in predictive accuracy, so it is assumed that a current block to be encoded moves in parallel over time, and matching is newly executed with an image in the reference frame Fn-2.

Let us say that distance on the temporal axis between this frame Fn and the reference Fn-1 is taken as tn-1, and distance on the temporal axis between the reference frame Fn-1 and the reference Fn-2 is taken as tn-2. A motion vector Ptmmv for moving the block blkn-1 in parallel with the reference frame Fn-2 is then obtained with the following Expression (34).

Ptmmv=(tn−2/tn−1)×tmmv (34)

However, with AVC, there is no information equivalent to the distance tn-1 or distance tn-2, so the POC (Picture Order Count) stipulated with the AVC standard is used. The POC is taken as a value indicating the display order of the frame thereof.

Also, with the predictive accuracy improving unit 90, (tn-2/tn-1) in Expression (34) may be approximated to an n/(2^{m}) format with the n and m as integers so as to be performed with a shift calculation alone without performing a division.

The predictive accuracy improving unit 90 extracts the data of the block blkn-2 on the reference frame Fn-2 determined based on the motion vector Ptmmv thus obtained from the frame memory 72.

Subsequently, the predictive accuracy improving unit 90 calculates predictive error between the block blkn-1 and the block blkn-2 based on the SAD. Now, let us say that the SAD value to be calculated as predictive error is taken as SAD2.

The predictive accuracy improving unit 90 calculates a cost function value evtm for evaluating the precision of the motion vector tmmv using Expression (35) based on the SAD1 and SAD2 thus obtained.

evtm=α×SAD1+β×SAD2 (35)

α and β in Expression (35) are predetermined weighting factors. Note that let us say that in the event that multiple sizes, such as 16×16 pixels, and 8×8 pixels, are defined as the size of an inter template matching block, different values of α and β are set as to a different block size, respectively.

The predictive accuracy improving unit 90 determines tmmv that minimizes the cost function value evtm as a template matching motion vector as to this block.

Note that, though the example has been described here wherein the cost function values are calculated based on SAD, the cost function values may be calculated by applying a residual energy calculation method such as SSD (Sum of Square Difference) or the like, for example.

Note that the processing described with reference to FIG. 21 can be performed only in the event that the two or more reference frames have been accumulated in the frame memory 72. For example, let us say that in the event that only the one reference frame can be used for a prediction image due to a reason such as this frame Fn being a frame immediately after an IDR (Instantaneous Decoder Refresh) picture, or the like, the inter template matching processing described with reference to FIG. 19 will be performed.

Thus, with the present invention, the cost function values for improving predictive accuracy between the reference frame Fn-1 and the reference frame Fn-2 is further calculated, and a moving vector is determined, based on a motion vector to be searched for by the inter template matching processing between this frame Fn and the reference frame Fn-1.

With a later-described image decoding device as well, decoding processing in the reference frame Fn-1 and the reference frame Fn-2 has already been completed at the time of the processing of this frame Fn being performed, whereby the same motion prediction can also be performed even with the decoding device. That is to say, predictive accuracy can be improved by the present invention, but on the other hand, there is no need to transmit the information of a motion vector as to the object block A, whereby the motion vector information in a compressed image can be reduced. Accordingly, deterioration in compression efficiency can be suppressed without increasing the calculation amount.

Note that the sizes of the blocks and templates in the inter template prediction mode are optional. That is to say, one block size may be used fixedly from the eight types of block sizes made up of 16×16 pixels through 4×4 pixels described above with FIG. 2, as with the motion prediction/compensation unit 77, or all block sizes may be taken as candidates. The template size may be variable in accordance with the block size, or may be fixed.

Next, a detailed example of the inter template motion prediction processing in step S34 of FIG. 5 will be described with reference to the flowchart in FIG. 22.

In step S71, the predictive accuracy improving unit 90 performs, as described above with reference to FIG. 21, matching processing of the template region tmpn and region tmpn-1 between this frame Fn and the reference frame Fn-1 based on the SAD (Sum of Absolute Difference) to calculate SAD1. Also, the predictive accuracy improving unit 90 calculates SAD2 as predictive error between the block blkn-2 on the reference frame Fn-2 and the block blkn-1 on the reference frame, determined based on the motion vector Ptmmv obtained with Expression (34).

In step S72, the predictive accuracy improving unit 90 calculates the cost function value evtm for evaluating the precision of the motion vector tmmv based on the SAD1 and SAD2 obtained in the processing in step S91, using Expression (35).

In step S73, the predictive accuracy improving unit 90 determines the tmmv that minimizes the cost function value evtm, as a template matching motion vector as to this block.

In step S74, the inter TP motion

prediction/compensation unit 78 calculates a cost function value as to the inter template prediction mode using Expression (36).

Cost(Mode)=evtm+λ·R (36)

Here, evtm is a cost function value calculated in step S72, R is generated code amount including orthogonal transform coefficients, and λ is a Lagrange multiplier given as a function of a quantization parameter QP.

Also, the cost function value as to the inter template prediction mode may be calculated with Expression (37).

Cost(Mode)=evtm+QPtoQuant(QP)·Header_Bit (37)

Here, evtm is a cost function value calculated in step S72, Header_Bit is a header bit as to the prediction mode, and QPtoQuant is a function given as a function of the quantization parameter QP.

Thus, the inter template motion prediction processing is performed.

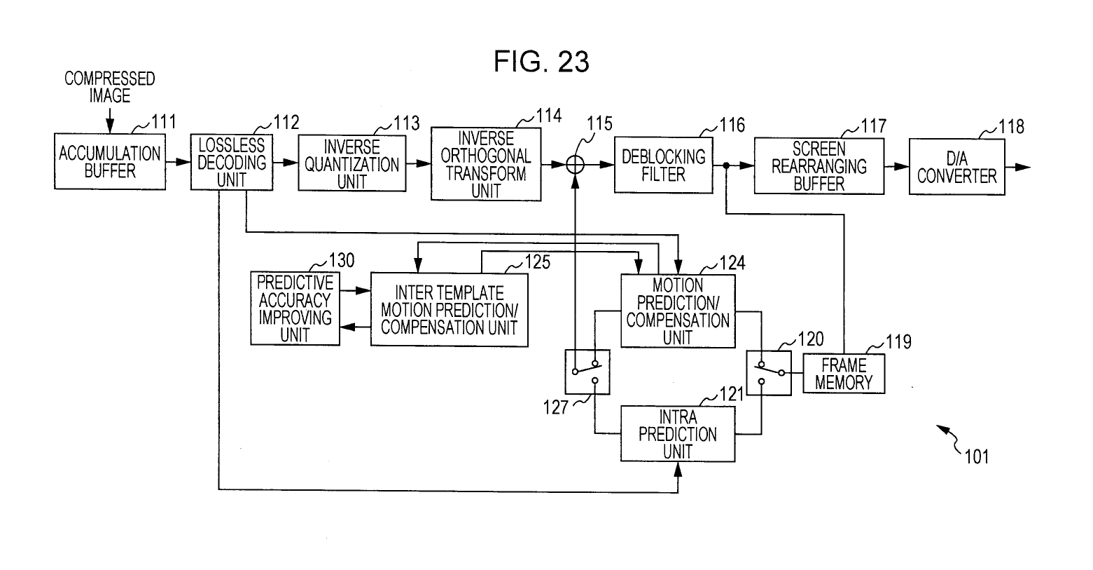

The encoded compressed image is transmitted over a predetermined transmission path, and is decoded by an image decoding device. FIG. 23 illustrates the configuration of one embodiment of such an image decoding device.

An image decoding device 101 is configured of an accumulation buffer 111, a lossless decoding unit 112, a inverse quantization unit 113, an inverse orthogonal transform unit 114, a computing unit 115, a deblocking filter 116, a screen rearranging buffer 117, a D/A converter 118, frame memory 119, a switch 120, a intra prediction unit 121, a motion prediction/compensation unit 124, an inter template motion prediction/compensation unit 125, a switch 127, and a predictive accuracy improving unit 130.

Note that in the following, the inter template motion prediction/compensation unit 125 will be referred to as inter TP motion prediction/compensation unit 125.

The accumulation buffer 111 accumulates compressed images transmitted thereto. The lossless decoding unit 112 decodes information encoded by the lossless encoding unit 66 in FIG. 1 that has been supplied from the accumulation buffer 111, with a format corresponding to the encoding format of the lossless encoding unit 66. The inverse quantization unit 113 performs inverse quantization of the image decoded by the lossless decoding unit 112, with a format corresponding to the quantization format of the quantization unit 65 in FIG. 1. The inverse orthogonal transform unit 114 performs inverse orthogonal transform of the output of the inverse quantization unit 113, with a format corresponding to the orthogonal transform format of the orthogonal transform unit 64 in FIG. 1.

The output of inverse orthogonal transform is added by the computing unit 115 with a prediction image supplied from the switch 127 and decoded. The deblocking filter 116 removes block noise in the decoded image, supplies to the frame memory 119 so as to be accumulated, and outputs to the screen rearranging buffer 117.

The screen rearranging buffer 117 performs rearranging of images. That is to say, the order of frames rearranged by the screen rearranging buffer 62 in FIG. 1 in the order for encoding, is rearranged to the original display order. The D/A converter 118 performs D/A conversion of images supplied from the screen rearranging buffer 117, and outputs to an unshown display for display.

The switch 120 reads out the image to be subjected to inter encoding and the image to be referenced from the frame memory 119, and outputs to the motion

prediction/compensation unit 124, and also reads out, from the frame memory 119, the image to be used for intra prediction, and supplies to the intra prediction unit 121.

Information relating to the intra prediction mode obtained by decoding header information is supplied to the intra prediction unit 121 from the lossless decoding unit 112. In the event that information is supplied to the effect of the intra prediction mode, the intra prediction unit 121 generates a prediction image based on this information. The intra prediction unit 121 outputs the generated prediction image to the switch 127.

Information obtained by decoding the header information (prediction mode, motion vector information, reference frame information) is supplied from the lossless decoding unit 112 to the motion prediction/compensation unit 124. In the event that information which is the inter prediction mode is supplied, the motion prediction/compensation unit 124 subjects the image to motion prediction and compensation processing based on the motion vector information and reference frame information, and generates a prediction image. In the event that information is supplied which is the inter template prediction mode, the motion prediction/compensation unit 124 supplies the image to which inter encoding is to be performed that has been read out from the frame memory 119 and the image to be referenced, to the inter TP motion prediction/compensation unit 125, so that motion prediction/compensation processing is performed in the inter template prediction mode.

Also, the motion prediction/compensation unit 124 outputs one of the prediction image generated with the inter prediction mode or the prediction image generated with the inter template prediction mode to the switch 127, in accordance to the prediction mode information.

The inter TP motion prediction/compensation unit 125 performs motion prediction and compensation processing in the inter template prediction mode, the same as the inter TP motion prediction/compensation unit 78 in FIG. 1. That is to say, the inter TP motion prediction/compensation unit 125 performs motion prediction and compensation processing in the inter template prediction mode based on the image to which inter encoding is to be performed that has been read out from the frame memory 119 and the image to be referenced, and generates a prediction image. At this time, inter TP motion prediction/compensation unit 125 performs motion prediction within the predetermined search range, as described above.

At this time, improvement in motion prediction is realized by the predictive accuracy improving unit 130. That is to say, the predictive accuracy improving unit 130 determines the information of the maximum likelihood motion vector (inter motion vector information) of motion vectors searched by motion prediction in the inter template prediction mode as with the case of the predictive accuracy improving unit 90 in FIG. 1.

The prediction image generated by the motion prediction/compensation processing in the inter template prediction mode is supplied to the motion prediction/compensation unit 124.

The switch 127 selects a prediction image generated by the motion prediction/compensation unit 124 or the intra prediction unit 121, and supplies this to the computing unit 115.

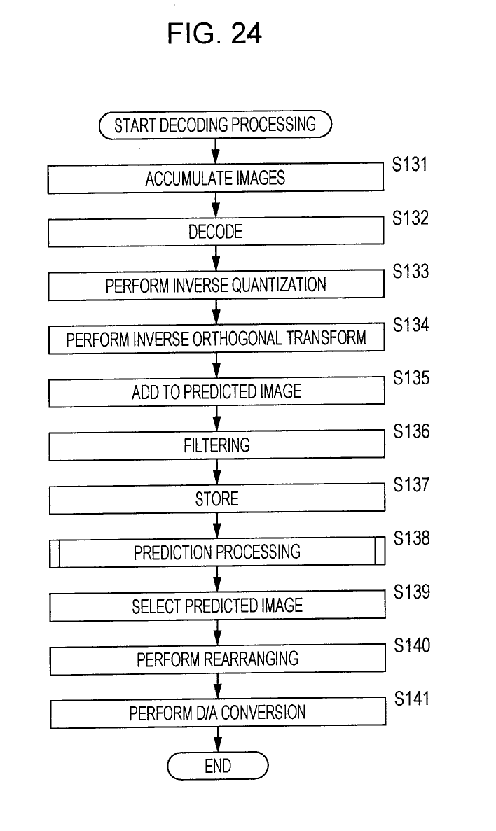

Next, the decoding processing which the image decoding device 101 executes will be described with reference to the flowchart in FIG. 24.

In step S131, the accumulation buffer 111 accumulates images transmitted thereto. In step S132, the lossless decoding unit 112 decodes compressed images supplied from the accumulation buffer 111. That is to say, the I picture, P pictures, and B pictures, encoded by the lossless encoding unit 66 in FIG. 1, are decoded.

At this time, motion vector information and prediction mode information (information representing intra prediction mode, inter prediction mode, or inter template prediction mode) is also decoded. That is to say, in the event that the prediction mode information is the intra prediction mode, the prediction mode information is supplied to the intra prediction unit 121. In the event that the prediction mode information is the inter prediction mode or inter template prediction mode, the prediction mode information is supplied to the motion prediction/compensation unit 124. At this time, in the event that there is corresponding motion vector information or reference frame information, that is also supplied to the motion prediction/compensation unit 124.

In step S133, the inverse quantization unit 113 performs inverse quantization of the transform coefficients decoded at the lossless decoding unit 112, with properties corresponding to the properties of the quantization unit 65 in FIG. 1. In step S134, the inverse orthogonal transform unit 114 performs inverse orthogonal transform of the transform coefficients subjected to inverse quantization at the inverse quantization unit 113, with properties corresponding to the properties of the orthogonal transform unit 64 in FIG. 1. Thus, difference information corresponding to the input of the orthogonal transform unit 64 (output of the computing unit 63) in FIG. 1 has been decoded.

In step S135, the computing unit 115 adds to the difference information, a prediction image selected in later-described processing of step S139 and input via the switch 127. Thus, the original image is decoded. In step S136, the deblocking filter 116 performs filtering of the image output from the computing unit 115. Thus, block noise is eliminated.

In step S137, the frame memory 119 stores the filtered image.

In step S138, the intra prediction unit 121, motion prediction/compensation unit 124, or inter TP motion prediction/compensation unit 125, each perform image prediction processing in accordance with the prediction mode information supplied from the lossless decoding unit 112.

That is to say, in the event that intra prediction mode information is supplied from the lossless decoding unit 112, the intra prediction unit 121 performs intra prediction processing in the intra prediction mode. Also, in the event that inter prediction mode information is supplied from the lossless decoding unit 112, the motion prediction/compensation unit 124 performs motion prediction/compensation processing in the inter prediction mode. In the event that inter template prediction mode information is supplied from the lossless decoding unit 112, the inter TP motion prediction/compensation unit 125 performs motion prediction/compensation processing in the inter template prediction mode.

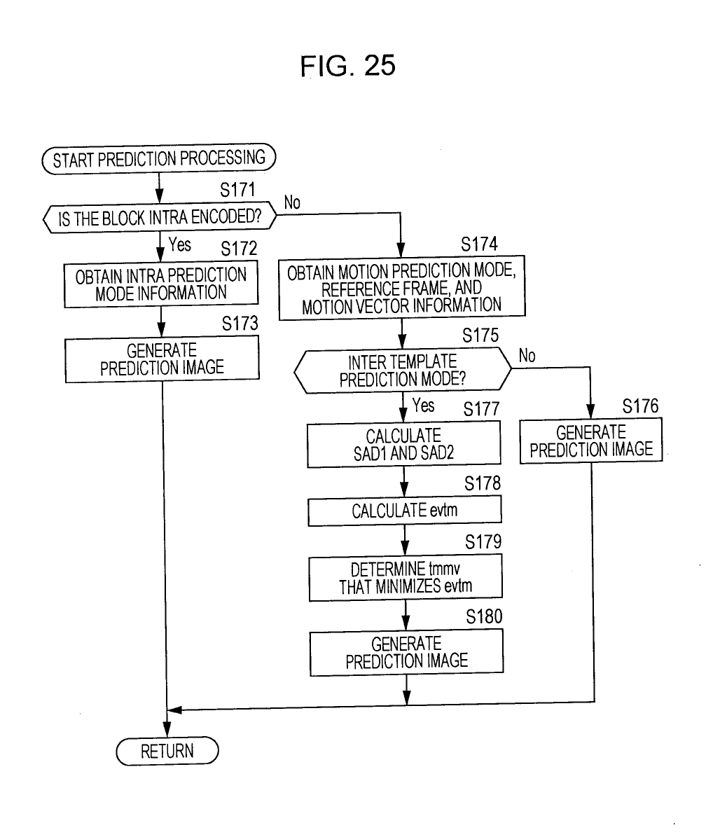

While details of the prediction processing in step S138 will be described later with reference to FIG. 25, due to this processing, a prediction image generated by the intra prediction unit 121, a prediction image generated by the motion prediction/compensation unit 124, or a prediction image generated by the inter TP motion prediction/compensation unit 125, is supplied to the switch 127.

In step S139, the switch 127 selects a prediction image. That is to say, a prediction image generated by the intra prediction unit 121, a prediction image generated by the motion prediction/compensation unit 124, or a prediction image generated by the inter TP motion prediction/compensation unit 125, is supplied, so the supplied prediction image is selected and supplied to the computing unit 115, and added to the output of the inverse orthogonal transform unit 114 in step S134 as described above.

In step S140, the screen rearranging buffer 117 performs rearranging. That is to say, the order for frames rearranged for encoding by the screen rearranging buffer 62 of the image encoding device 51 is rearranged in the original display order.

In step S141, the D/A converter 118 performs D/A conversion of the image from the screen rearranging buffer 117. This image is output to an unshown display, and the image is displayed.

Next, the prediction processing of step S138 in FIG. 24 will be described with reference to the flowchart in FIG. 25.

In step S171, the intra prediction unit 121 determines whether or not the object block has been subjected to intra encoding. In the event that intra prediction mode information is supplied from the lossless decoding unit 112 to the intra prediction unit 121, the intra prediction unit 121 determines in step S171 that the object block has been subjected to intra encoding, and the processing advances to step S172.

In step S172, the intra prediction unit 121 obtains intra prediction mode information.

In step S173, an image necessary for processing is read out from the frame memory 119, and also the intra prediction unit 121 performs intra prediction following the intra prediction mode information obtained in step S172, and generates a prediction image.

On the other hand, in step S171, in the event that determination is made that there has been no intra encoding, the processing advances to step S174.

In this case, since the image to be processed is an image subjected to inter processing, a necessary image is read out from the frame memory 119, and is supplied to the motion prediction/compensation unit 124 via the switch 120. In step S174, the motion prediction/compensation unit 124, the motion prediction/compensation unit 124 obtains inter prediction mode information, reference frame information, and motion vector information from the lossless decoding unit 112.

In step S175, the motion prediction/compensation unit 124 determines whether or not the prediction mode of the image to be processed is the inter template prediction mode, based on the inter prediction mode information from the lossless decoding unit 112.

In the event that determination is made that this is not the inter template prediction mode, in step S176, the motion prediction/compensation unit 124 predicts the motion in the inter prediction mode, and generates a prediction image, based on the motion vector obtained in step S174.

On the other hand, in the event that determination is made in step S175 that this is the inter template prediction mode, the processing advances to step S177.

In step S177, the predictive accuracy improving unit 130 performs, as described with reference to FIG. 21, the matching processing of the template region tmpn and the region tmpn-1 between this frame Fn and the reference frame Fn-1 based on the SAD (Sum of Absolute Difference) to calculate SAD1. Also, the predictive accuracy improving unit 130 calculates SAD2 as prediction error between the block blkn-2 on the reference frame Fn-2 and the block blkn-1 on the reference frame Fn-1 determined based on the motion vector Ptmmv obtained with Expression (34).

In step S178, the predictive accuracy improving unit 130 calculates the cost function value evtm for evaluating the precision of the motion vector tmmv by expression (35) based on the SAD1 and SAD2 obtained in the processing in step S177.

In step S179, the predictive accuracy improving unit 130 determines the tmmv that minimizes the cost function value evtm as a template matching motion vector as to this block.

In step S180, the inter TP motion prediction/compensation unit 125 performs motion prediction in the inter template prediction mode and generates a prediction image, based on the motion vector determined in step S179.

Thus, prediction processing is performed.

As described above, with the present invention, motion prediction is performed with an image encoding device and image decoding device, based on template matching where motion searching is performed using a decoded image, so good image quality can be displayed without sending motion vector information.

Also, at this time, an arrangement is made wherein a cost function value is further calculated between the reference frame Fn-1 and the reference frame Fn-2 regarding the motion vector searched by the inter plate matching processing between this frame Fn and the reference frame Fn-1, whereby predictive accuracy can be improved.

Accordingly, while predictive accuracy can be improved by the present invention, deterioration in compression efficiency can be suppressed without increasing the computation amount.

Note that while description has been made in the above description regarding a case in which the size of a macro block is 16×16 pixels, the present invention is applicable to extended macro block sizes described in “Video Coding Using Extended Block Sizes”, VCEG-AD09, ITU-Telecommunications Standardization Sector STUDY GROUP Question 16—Contribution 123, January 2009.

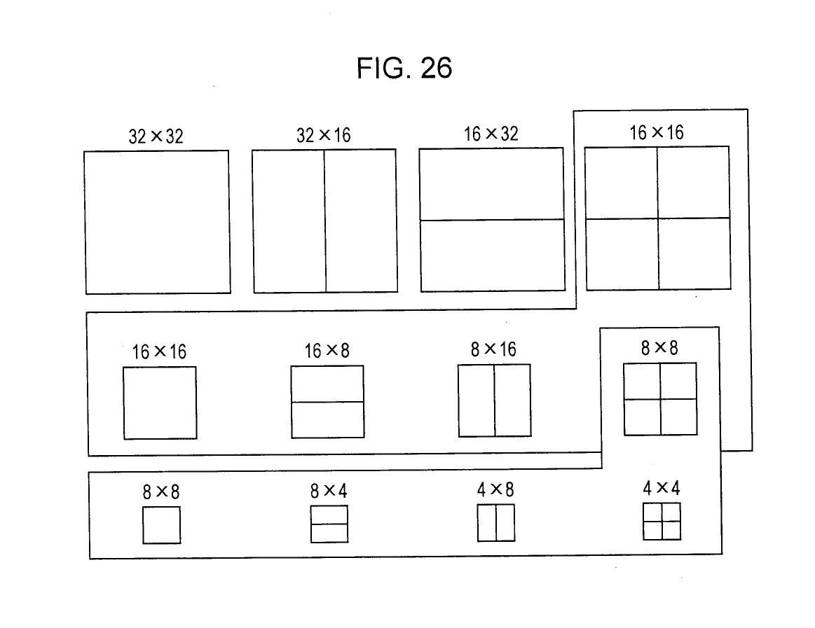

FIG. 26 is a diagram illustrating an example of extended macro block sizes. With the above description, the macro block size is extended to 32×32 pixels.

Shown in order at the upper tier in FIG. 26 are macro blocks configured of 32×32 pixels that have been divided into blocks (partitions) of, from the left, 32×32 pixels, 32×16 pixels, 16×32 pixels, and 16×16 pixels. Shown at the middle tier in FIG. 26 are macro blocks configured of 16×16 pixels that have been divided into blocks (partitions) of, from the left, 16×16 pixels, 16×8 pixels, 8×16 pixels, and 8×8 pixels. Shown at the lower tier in FIG. 26 are macro blocks configured of 8×8 pixels that have been divided into blocks (partitions) of, from the left, 8×8 pixels, 8×4 pixels, 4×8 pixels, and 4×4 pixels.

That is to say, macro blocks of 32×32 pixels can be processed as blocks of 32×32 pixels, 32×16 pixels, 16×32 pixels, and 16×16 pixels, shown in the upper tier in FIG. 26.

Also, the 16×16 pixel block shown to the right side of the upper tier can be processed as blocks of 16×16 pixels, 16×8 pixels, 8×16 pixels, and 8×8 pixels, shown in the middle tier, in the same way as with the H.264/AVC format.

Further, the 8×8 pixel block shown to the right side of the middle tier can be processed as blocks of 8×8 pixels, 8×4 pixels, 4×8 pixels, and 4×4 pixels, shown in the lower tier, in the same way as with the H.264/AVC format.

By employing such a hierarchical structure, with the extended macro block sizes, compatibility with the H.264/AVC format regarding 16×16 pixel and smaller blocks is maintained, while defining larger blocks as a superset thereof.

The present invention can also be applied to extended macro block sizes as proposed above.

Also, while description has been made using the H.264/AVC format as an encoding format, other encoding formats/decoding formats may be used.

Note that the present invention may be applied to image encoding devices and image decoding devices at the time of receiving image information (bit stream) compressed by orthogonal transform and motion compensation such as discrete cosine transform or the like, as with MPEG, H.26x, or the like for example, via network media such as satellite broadcasting, cable TV (television), the Internet, and cellular telephones or the like, or at the time of processing on storage media such as optical or magnetic discs, flash memory, and so forth.

The above-described series of processing may be executed by hardware, or may be executed by software. In the event that the series of processing is to be executed by software, the program making up the software is installed from a program recording medium to a computer built into dedicated hardware, or a general-purpose personal computer capable of executing various types of functions by installing various types of programs, for example.

The program recording media for storing the program which is to be installed to the computer so as to be in a computer-executable state, is configured of removable media which is packaged media such as magnetic disks (including flexible disks), optical discs (including CD-ROM (Compact Disc-Read Only Memory), DVD (Digital Versatile Disc), and magneto-optical discs), or semiconductor memory or the like, or, ROM or hard disks or the like where programs are temporarily or permanently stored. Storing of programs to the recording media is performed using cable or wireless communication media such as local area networks, the Internet, digital satellite broadcasting, and so forth, via interfaces such as routers, modems, and so forth, as necessary.

Note that the steps describing the program in the present specification include processing being performed in the time-sequence of the described order as a matter of course, but also include processing being executed in parallel or individually, not necessarily in time-sequence.

Also note that the embodiments of the present invention are not restricted to the above-described embodiments, and that various modifications may be made without departing from the essence of the present invention.

For example, the above-described image encoding device 51 and image decoding device 101 can be applied to an optional electronic device. An example of this will be described next.

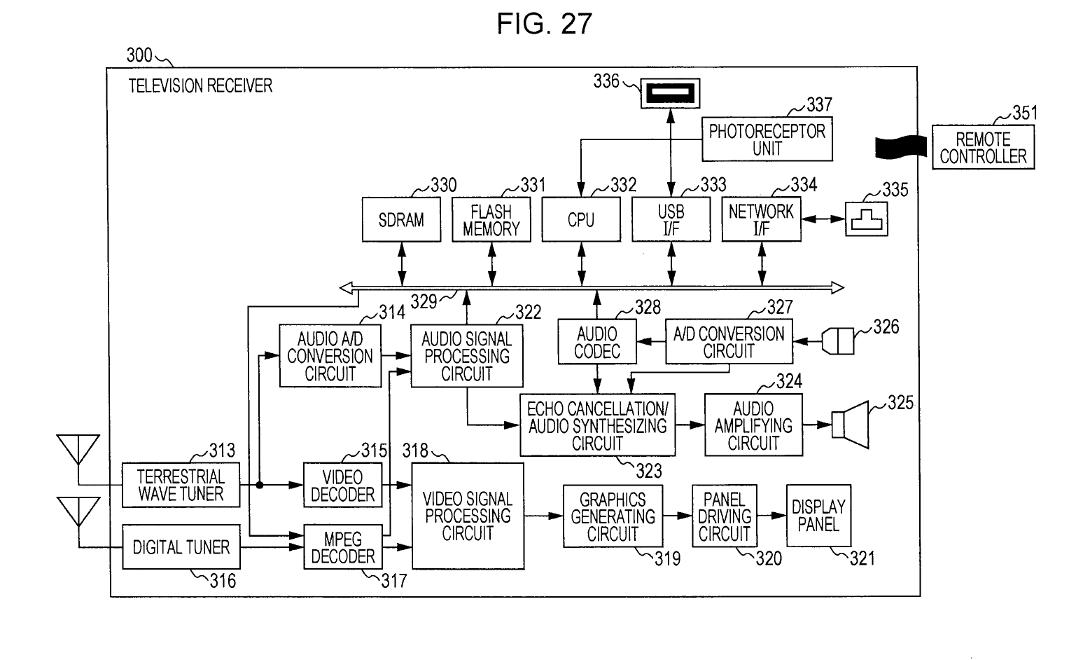

FIG. 27 is a block diagram illustrating a primary configuration example of a television receiver using an image decoding device to which the present invention has been applied.

A television receiver 300 shown in FIG. 27 includes a terrestrial wave tuner 313, a video decoder 315, a video signal processing circuit 318, a graphics generating circuit 319, a panel driving circuit 320, and a display panel 321.

The terrestrial wave tuner 313 receives broadcast wave signals of terrestrial analog broadcasting via an antenna and demodulates these, and obtains video signals which are supplied to the video decoder 315. The video decoder 315 subjects the video signals supplied from the terrestrial wave tuner 313 to decoding processing, and supplies the obtained digital component signals to the video signal processing circuit 318.

The video signal processing circuit 318 subjects the video data supplied from the video decoder 315 to predetermined processing such as noise reduction and so forth, and supplies the obtained video data to the graphics generating circuit 319.

The graphics generating circuit 319 generates video data of a program to be displayed on the display panel 321, image data by processing based on applications supplied via network, and so forth, and supplies the generated video data and image data to the panel driving circuit 320. Also, the graphics generating circuit 319 performs processing such as generating video data (graphics) for displaying screens to be used by users for selecting items and so forth, and supplying video data obtained by superimposing this on the video data of the program to the panel driving circuit 320, as appropriate.

The panel driving circuit 320 drives the display panel 321 based on data supplied from the graphics generating circuit 319, and displays video of programs and various types of screens described above on the display panel 321.

The display panel 321 is made up of an LCD (Liquid Crystal Display) or the like, and displays video of programs and so forth following control of the panel driving circuit 320.

The television receiver 300 also has an audio A/D (Analog/Digital) conversion circuit 314, audio signal processing circuit 322, echo cancellation/audio synthesizing circuit 323, audio amplifying circuit 324, and speaker 325.

The terrestrial wave tuner 313 obtains not only video signals but also audio signals by demodulating the received broadcast wave signals. The terrestrial wave tuner 313 supplies the obtained audio signals to the audio A/D conversion circuit 314.

The audio A/D conversion circuit 314 subjects the audio signals supplied from the terrestrial wave tuner 313 to A/D conversion processing, and supplies the obtained digital audio signals to the audio signal processing circuit 322.

The audio signal processing circuit 322 subjects the audio data supplied from the audio A/D conversion circuit 314 to predetermined processing such as noise removal and so forth, and supplies the obtained audio data to the echo cancellation/audio synthesizing circuit 323.

The echo cancellation/audio synthesizing circuit 323 supplies the audio data supplied from the audio signal processing circuit 322 to the audio amplifying circuit 324.

The audio amplifying circuit 324 subjects the audio data supplied from the echo cancellation/audio synthesizing circuit 323 to D/A conversion processing and amplifying processing, and adjustment to a predetermined volume, and then audio is output from the speaker 325.

Further, the television receiver 300 also includes a digital tuner 316 and MPEG decoder 317.

The digital tuner 316 receives broadcast wave signals of digital broadcasting (terrestrial digital broadcast, BS (Broadcasting Satellite)/CS (Communications Satellite) digital broadcast) via an antenna, demodulates, and obtains MPEG-TS (Moving Picture Experts Group-Transport Stream), which is supplied to the MPEG decoder 317.

The MPEG decoder 317 unscrambles the scrambling to which the MPEG-TS supplied from the digital tuner 316 had been subjected to, and extracts a stream including data of a program to be played (to be viewed and listened to). The MPEG decoder 317 decodes audio packets making up the extracted stream, supplies the obtained audio data to the audio signal processing circuit 322, and also decodes video packets making up the stream and supplies the obtained video data to the video signal processing circuit 318. Also, the MPEG decoder 317 supplies EPG (Electronic Program Guide) data extracted from the MPEG-TS to the CPU 332 via an unshown path.

The television receiver 300 uses the above-described image decoding device 101 as the MPEG decoder 317 to decode video packets in this way. Accordingly, in the same way as with the case of the image decoding device 101, the MPEG decoder 317 further calculates the cost function value between reference frames regarding the motion vector to be searched by the inter template matching processing between this frame and a reference frame. Thus, predictive accuracy can be improved.

The video data supplied from the MPEG decoder 317 is subjected to predetermined processing at the video signal processing circuit 318, in the same way as with the case of the video data supplied from the video decoder 315. The video data subjected to predetermined processing is superimposed with generated video data as appropriate at the graphics generating circuit 319, supplied to the display panel 321 by way of the panel driving circuit 320, and the image is displayed.

The audio data supplied from the MPEG decoder 317 is subjected to predetermined processing at the audio signal processing circuit 322, in the same way as with the audio data supplied from the audio A/D conversion circuit 314. The audio data subjected to the predetermined processing is supplied to the audio amplifying circuit 324 via the echo cancellation/audio synthesizing circuit 323, and is subjected to D/A conversion processing and amplification processing. As a result, audio adjusted to a predetermined volume is output from the speaker 325.

Also, the television receiver 300 also has a microphone 326 and an A/D conversion circuit 327.

The A/D conversion circuit 327 receives signals of audio from the user, collected by the microphone 326 provided to the television receiver 300 for voice conversation. The A/D conversion circuit 327 subjects the received audio signals to A/D conversion processing, and supplies the obtained digital audio data to the echo cancellation/audio synthesizing circuit 323.

In the event that the audio data of the user (user A) of the television receiver 300 is supplied from the A/D conversion circuit 327, the echo cancellation/audio synthesizing circuit 323 performs echo cancellation on the audio data of the user A. Following echo cancellation, the echo cancellation/audio synthesizing circuit 323 outputs the audio data obtained by synthesizing with other audio data and so forth, to the speaker 325 via the audio amplifying circuit 324.

Further, the television receiver 300 also has an audio codec 328, an internal bus 329, SDRAM (Synchronous Dynamic Random Access Memory) 330, flash memory 331, a CPU 332, a USB (Universal Serial Bus) I/F 333, and a network I/F 334.

The A/D conversion circuit 327 receives audio signals of the user input by the microphone 326 provided to the television receiver 300 for voice conversation. The A/D conversion circuit 327 subjects the received audio signals to A/D conversion processing, and supplies the obtained digital audio data to the audio codec 328.

The audio codec 328 converts the audio data supplied from the A/D conversion circuit 327 into data of a predetermined format for transmission over the network, and supplies to the network I/F 334 via the internal bus 329.

The network I/F 334 is connected to a network via a cable connected to a network terminal 335. The network I/F 334 transmits audio data supplied from the audio codec 328 to another device connected to the network, for example. Also, the network I/F 334 receives audio data transmitted from another device connected via the network by way of the network terminal 335, and supplies this to the audio codec 328 via the internal bus 329.

The audio codec 328 converts the audio data supplied from the network I/F 334 into data of a predetermined format, and supplies this to the echo cancellation/audio synthesizing circuit 323.

The echo cancellation/audio synthesizing circuit 323 performs echo cancellation on the audio data supplied from the audio codec 328, and outputs audio data obtained by synthesizing with other audio data and so forth from the speaker 325 via the audio amplifying circuit 324.

The SDRAM 330 stores various types of data necessary for the CPU 332 to perform processing.

The flash memory 331 stores programs to be executed by the CPU 332. Programs stored in the flash memory 331 are read out by the CPU 332 at a predetermined timing, such as at the time of the television receiver 300 starting up. The flash memory 331 also stores EPG data obtained by way of digital broadcasting, data obtained from a predetermined server via the network, and so forth.

For example, the flash memory 331 stores MPEG-TS including content data obtained from a predetermined server via the network under control of the CPU 332. The flash memory 331 supplies the MPEG-TS to a MPEG decoder 317 via the internal bus 329, under control of the CPU 332, for example.

The MPEG decoder 317 processes the MPEG-TS in the same way as with an MPEG-TS supplied from the digital tuner 316. In this way, with the television receiver 300, content data made up of video and audio and the like is received via the network and decoded using the MPEG decoder 317, whereby the video can be displayed and the audio can be output.

Also, the television receiver 300 also has a photoreceptor unit 337 for receiving infrared signals transmitted from a remote controller 351.

The photoreceptor unit 337 receives the infrared rays from the remote controller 351, and outputs control code representing the contents of user operations obtained by demodulation thereof to the CPU 332.

The CPU 332 executes programs stored in the flash memory 331 to control the overall operations of the television receiver 300 in accordance with control code and the like supplied from the photoreceptor unit 337. The CPU 332 and the parts of the television receiver 300 are connected via an unshown path.

The USB I/F 333 performs exchange of data with external devices from the television receiver 300 that are connected via a USB cable connected to the USB terminal 336. The network I/F 334 connects to the network via a cable connected to the network terminal 335, and exchanges data other than audio data with various types of devices connected to the network.

The television receiver 300 can improve predictive accuracy by using the image decoding device 101 as the MPEG decoder 317. As a result, the television receiver 300 can obtain and display higher definition decoded images from broadcasting signals received via the antenna and content data obtained via the network.

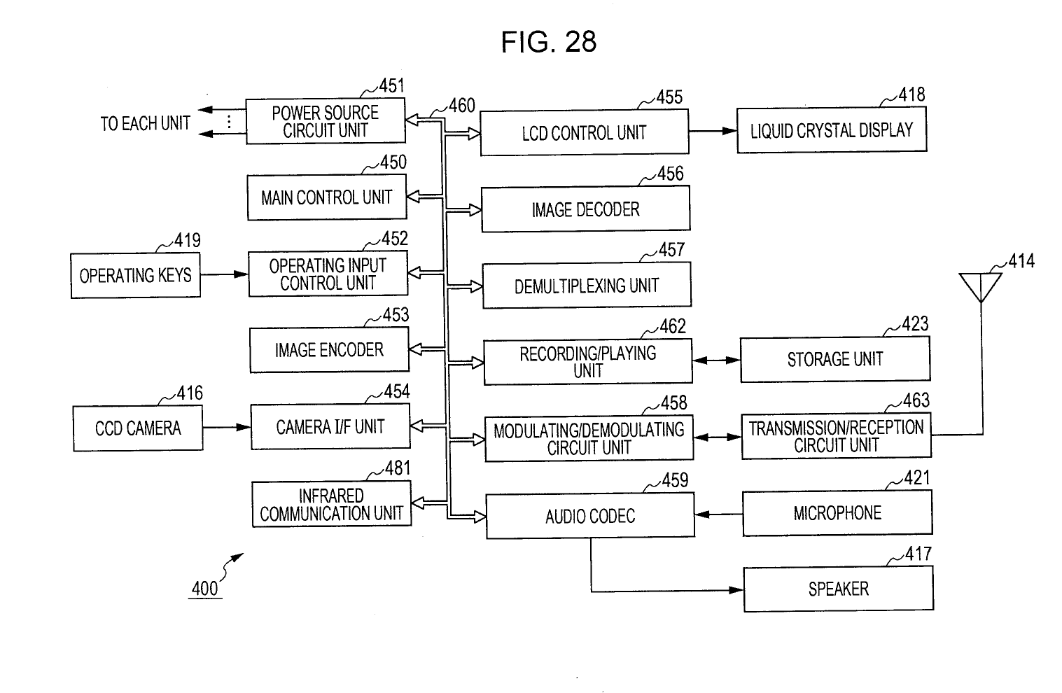

FIG. 28 is a block diagram illustrating an example of the principal configuration of a cellular telephone using the image encoding device and image decoding device to which the present invention has been applied.

A cellular telephone 400 illustrated in FIG. 28 includes a main control unit 450 arranged to centrally control each part, a power source circuit unit 451, an operating input control unit 452, an image encoder 453, a camera I/F unit 454, an LCD control unit 455, an image decoder 456, a demultiplexing unit 457, a recording/playing unit 462, a modulating/demodulating unit 458, and an audio codec 459. These are mutually connected via a bus 460.

Also, the cellular telephone 400 has operating keys 419, a CCD (Charge Coupled Device) camera 416, a liquid crystal display 418, a storage unit 423, a transmission/reception circuit unit 463, an antenna 414, a microphone (mike) 421, and a speaker 417.

The power source circuit unit 451 supplies electric power from a battery pack to each portion upon an on-hook or power key going to an on state by user operations, thereby activating the cellular telephone 400 to an operable state.

The cellular telephone 400 performs various types of operations such as exchange of audio signals, exchange of email and image data, image photography, data recording, and so forth, in various types of modes such as audio call mode, data communication mode, and so forth, under control of the main control unit 450 made up of a CPU, ROM, and RAM.

For example, in an audio call mode, the cellular telephone 400 converts audio signals collected at the microphone (mike) 421 into digital audio data by the audio codec 459, performs spread spectrum processing thereof at the modulating/demodulating unit 458, and performs digital/analog conversion processing and frequency conversion processing at the transmission/reception circuit unit 463. The cellular telephone 400 transmits the transmission signals obtained by this conversion processing to an unshown base station via the antenna 414. The transmission signals (audio signals) transmitted to the base station are supplied to a cellular telephone of the other party via a public telephone line network.

Also, for example, in the audio call mode, the cellular telephone 400 amplifies the reception signals received at the antenna 414 with the transmission/reception circuit unit 463, further performs frequency conversion processing and analog/digital conversion, and performs inverse spread spectrum processing at the modulating/demodulating unit 458, and converts into analog audio signals by the audio codec 459. The cellular telephone 400 outputs the analog audio signals obtained by this conversion from the speaker 417.

Further, in the event of transmitting email in the data communication mode for example, the cellular telephone 400 accepts text data of the email input by operations of the operating keys 419 at the operating input control unit 452. The cellular telephone 400 processes the text data at the main control unit 450, and displays this as an image on the liquid crystal display 418 via the LCD control unit 455.

Also, at the main control unit 450, the cellular telephone 400 generates email data based on text data which the operating input control unit 452 has accepted and user instructions and the like. The cellular telephone 400 performs spread spectrum processing of the email data at the modulating/demodulating unit 458, and performs digital/analog conversion processing and frequency conversion processing at the transmission/reception circuit unit 463. The cellular telephone 400 transmits the transmission signals obtained by this conversion processing to an unshown base station via the antenna 414. The transmission signals (email) transmitted to the base station are supplied to the predetermined destination via a network, mail server, and so forth.

Also, for example, in the event of receiving email in data communication mode, the cellular telephone 400 receives and amplifies signals transmitted from the base station with the transmission/reception circuit unit 463 via the antenna 414, further performs frequency conversion processing and analog/digital conversion processing. The cellular telephone 400 performs inverse spread spectrum processing at the modulating/demodulating circuit unit 458 on the received signals to restore the original email data. The cellular telephone 400 displays the restored email data in the liquid crystal display 418 via the LCD control unit 455.

Note that the cellular telephone 400 can also record (store) the received email data in the storage unit 423 via the recording/playing unit 462.

The storage unit 423 may be any rewritable storage medium. The storage unit 423 may be semiconductor memory such as RAM or built-in flash memory or the like, or may be a hard disk, or may be removable media such as a magnetic disk, magneto-optical disk, optical disc, USB memory, or memory card or the like, and of course, be something other than these.

Further, in the event of transmitting image data in the data communication mode for example, the cellular telephone 400 generates image data with the CCD camera 416 by imaging. The CCD camera 416 has an optical device such as a lens and diaphragm and the like, and a CCD as a photoelectric conversion device, to image a subject, convert the intensity of received light into electric signals, and generate image data of an image of the subject. The image data is converted into encoded image data by performing compressing encoding by a predetermined encoding method such as MPEG2 or MPEG4 for example, at the image encoder 453, via the camera I/F unit 454.

The cellular telephone 400 uses the above-described image encoding device 51 as the image encoder 453 for performing such processing. Accordingly, as with the case of the image encoding device 51, the image encoder 453 further calculates a cost function value between reference frames regarding the motion vector searched by the inter template matching processing between this frame and a reference frame. Thus, predictive accuracy can be improved.

Note that at the same time as this, the cellular telephone 400 subjects the audio collected with the microphone (mike) 421 during imaging with the CCD camera 416 to analog/digital conversion at the audio codec 459, and further encodes.

At the demultiplexing unit 457, the cellular telephone 400 multiplexes the encoded image data supplied from the image encoder 453 and the digital audio data supplied from the audio codec 459, with a predetermined method. The cellular telephone 400 subjects the multiplexed data obtained as a result thereof to spread spectrum processing at the modulating/demodulating circuit unit 458, and performs digital/analog conversion processing and frequency conversion processing at the transmission/reception circuit unit 463. The cellular telephone 400 transmits the transmission signals obtained by this conversion processing to an unshown base station via the antenna 414. The transmission signals (image data) transmitted to the base station are supplied to the other party of communication via a network and so forth.

Note that, in the event of not transmitting image data, the cellular telephone 400 can display the image data generated at the CCD camera 416 on the liquid crystal display 418 via the LCD control unit 455 without going through the image encoder 453.

Also, for example, in the event of receiving data of a moving image file linked to a simple home page or the like, the cellular telephone 400 receives the signals transmitted from the base station with the transmission/reception circuit unit 463 via the antenna 414, amplifies these, and further performs frequency conversion processing and analog/digital conversion processing. The cellular telephone 400 performs inverse spread spectrum processing of the received signals at the modulating/demodulating unit 458 to restore the original multiplexed data. The cellular telephone 400 separates the multiplexed data at the demultiplexing unit 457, and divides into encoded image data and audio data.

At the image decoder 456, the cellular telephone 400 decodes the encoded image data with a decoding method corresponding to the predetermined encoding method such as MPEG2 or MPEG4 or the like, thereby generating playing moving image data, which is displayed on the liquid crystal display 418 via the LCD control unit 455. Thus, the moving image data included in the moving image file linked to the simple home page, for example, is displayed on the liquid crystal display 418.

The cellular telephone 400 uses the above-described image decoding device 101 as an image decoder 456 for performing such processing, accordingly, in the same way as with the image decoding device 101, the image decoder 456 further calculates a cost function value between reference frames regarding the motion vector searched by the inter template matching processing between this frame and a reference frame. Thus, predictive accuracy can be improved.

At this time, the cellular telephone 400 converts the digital audio data into analog audio signals at the audio codec 459 at the same time, and outputs this from the speaker 417. Thus, audio data included in the moving image file linked to the simple home page, for example, is played.

Note that, in the same way as with the case of email, the cellular telephone 400 can also record (store) the data linked to the received simple homepage or the like in the storage unit 423 via the recording/playing unit 462.

Also, the cellular telephone 400 can analyze two-dimensional code obtained by being taken with the CCD camera 416 at the main control unit 450, so as to obtain information recorded in the two-dimensional code.

Further, the cellular telephone 400 can communicate with an external device by infrared rays with an infrared communication unit 481.

By using the image encoding device 51 as the image encoder 453, the cellular telephone 400 can, for example, improve the encoding efficiency of encoded data generated by encoding the image data generated at the CCD camera 416. As a result, the cellular telephone 400 can provide encoded data (image data) with good encoding efficiency to other devices.

Also, using the image encoding device 101 as the image encoder 456, the cellular telephone 400 can generate prediction images with high precision. As a result, the cellular telephone 400 can obtain and display decoded images with higher definition from a moving image file linked to a simple home page, for example.

Note that while the cellular telephone 400 has been described above so as to use a CCD camera 416, an image sensor (CMOS image sensor) using a CMOS (Complementary Metal Oxide Semiconductor) may be used instead of the CCD camera 416. In this case as well, the cellular telephone 400 can image subjects and generate image data of images of the subject, in the same way as with using the CCD camera 416.

Also, while the above description has been made with a cellular telephone 400, the image encoding device 51 and image decoding device 101 can be applied to any device in the same way as with the cellular telephone 400, as long as the device has imaging functions and communication functions the same as with the cellular telephone 400, such as for example, a PDA (Personal Digital Assistants), smart phone, UMPC (Ultra Mobile Personal Computer), net book, laptop personal computer, or the like.

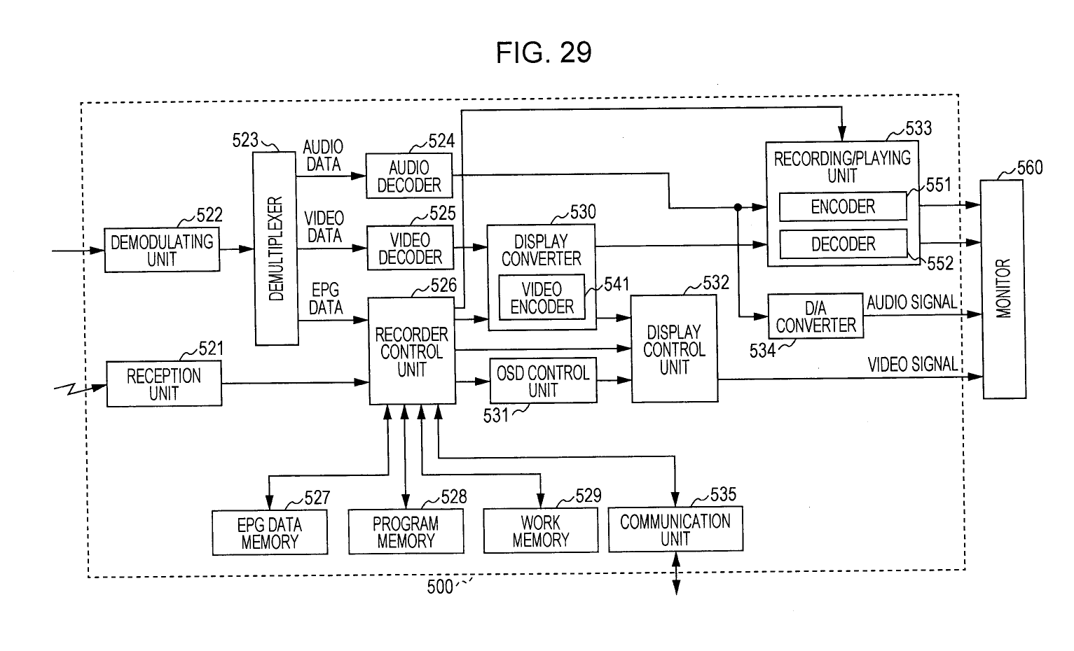

FIG. 29 is a block diagram illustrating an example of a primary configuration of a hard disk recorder using the image encoding device and image decoding device to which the present invention has been applied.

The hard disk recorder (HDD recorder) 500 shown in FIG. 29 is a device which saves audio data and video data included in a broadcast program included in broadcast wave signals (television signals) transmitted from a satellite or terrestrial antenna or the like, that have been received by a tuner, in a built-in hard disk, and provides the saved data to the user at an instructed timing.

The hard disk recorder 500 can extract the audio data and video data from broadcast wave signals for example, decode these as appropriate, and store in the built-in hard disk. Also, the hard disk recorder 500 can, for example, obtain audio data and video data from other devices via a network, decode these as appropriate, and store in the built-in hard disk.

Further, for example, the hard disk recorder 500 decodes the audio data and video data recorded in the built-in hard disk and supplies to a monitor 560, so as to display the image on the monitor 560. Also, the hard disk recorder 500 can output the audio thereof from the speaker of the monitor 560.

The hard disk recorder 500 can also, for example, decode and supply audio data and video data extracted from broadcast wave signals obtained via the tuner, or audio data and video data obtained from other devices via the network, to the monitor 560, so as to display the image on the monitor 560. Also, the hard disk recorder 500 can output the audio thereof from the speaker of the monitor 560.

Of course, other operations can be performed as well.

As shown in FIG. 29, the hard disk recorder 500 has a reception unit 521, demodulating unit 522, demultiplexer 523, audio decoder 524, video decoder 525, and recorder control unit 526. The hard disk recorder 500 further has EPG data memory 527, program memory 528, work memory 529, a display converter 530, an OSD (On Screen Display) control unit 531, a display control unit 532, a recording/playing unit 533, a D/A converter 534, and a communication unit 535.

Also, the display converter 530 has a video encoder 541. The recording/playing unit 533 has an encoder 551 and decoder 552.

The reception unit 521 receives infrared signals from a remote controller (not shown), converts into electric signals, and outputs to the recorder control unit 526. The recorder control unit 526 is configured of a microprocessor or the like, for example, and executes various types of processing following programs stored in the program memory 528. The recorder control unit 526 uses the work memory 529 at this time as necessary.

The communication unit 535 is connected to a network, and performs communication processing with other devices via the network. For example, the communication unit 535 is controlled by the recorder control unit 526 to communicate with a tuner (not shown) and primarily output channel tuning control signals to the tuner.

The demodulating unit 522 demodulates the signals supplied from the tuner, and outputs to the demultiplexer 523. The demultiplexer 523 divides the data supplied from the demodulating unit 522 into audio data, video data, and EPG data, and outputs these to the audio decoder 524, video decoder 525, and recorder control unit 526, respectively.

The audio decoder 524 decodes the input audio data by the MPEG format for example, and outputs to the recording/playing unit 533. The video decoder 525 decodes the input video data by the MPEG format for example, and outputs to the display converter 530. The recorder control unit 526 supplies the input EPG data to the EPG data memory 527 so as to be stored.

The display converter 530 encodes video data supplied from the video decoder 525 or the recorder control unit 526 into NTSC (National Television Standards Committee) format video data with the video encoder 541 for example, and outputs to the recording/playing unit 533. Also, the display converter 530 converts the size of the screen of the video data supplied from the video decoder 525 or the recorder control unit 526 to a size corresponding to the size of the monitor 560. The display converter 530 further converts the video data of which the screen size has been converted into NTSC video data by the video encoder 541, performs conversion into analog signals, and outputs to the display control unit 532.

Under control of the recorder control unit 526, the display control unit 532 superimposes OSD signals output from the OSD (On Screen Display) control unit 531 into video signals input from the display converter 530, and outputs to the display of the monitor 560 to be displayed.

The monitor 560 is also supplied with the audio data output from the audio decoder 524 that has been converted into analog signals by the D/A converter 534. The monitor 560 can output the audio signals from a built-in speaker.

The recording/playing unit 533 has a hard disk as a storage medium for recording video data and audio data and the like.

The recording/playing unit 533 encodes the audio data supplied from the audio decoder 524 for example, with the MPEG format by the encoder 551. Also, the recording/playing unit 533 encodes the video data supplied from the video encoder 541 of the display converter 530 with the MPEG format by the encoder 551. The recording/playing unit 533 synthesizes the encoded data of the audio data and the encoded data of the video data with a multiplexer. The recording/playing unit 533 performs channel coding of the synthesized data and amplifies this, and writes the data to the hard disk via a recording head.

The recording/playing unit 533 plays the data recorded in the hard disk via the recording head, amplifies, and separates into audio data and video data with a demultiplexer. The recording/playing unit 533 decodes the audio data and video data with the MPEG format by the decoder 552. The recording/playing unit 533 performs D/A conversion of the decoded audio data, and outputs to the speaker of the monitor 560. Also, the recording/playing unit 533 performs D/A conversion of the decoded video data, and outputs to the display of the monitor 560.

The recorder control unit 526 reads out the newest EPG data from the EPG data memory 527 based on user instructions indicated by infrared ray signals from the remote controller received via the reception unit 521, and supplies these to the OSD control unit 531. The OSD control unit 531 generates image data corresponding to the input EPG data, which is output to the display control unit 532. The display control unit 532 outputs the video data input from the OSD control unit 531 to the display of the monitor 560 so as to be displayed. Thus, an EPG (electronic program guide) is displayed on the display of the monitor 560.

Also, the hard disc recorder 500 can obtain various types of data supplied from other devices via a network such as the Internet, such as video data, audio data, EPG data, and so forth.

The communication unit 535 is controlled by the recorder control unit 526 to obtain encoded data such as video data, audio data, EPG data, and so forth, transmitted from other devices via the network, and supplies these to the recorder control unit 526. The recorder control unit 526 supplies the obtained encoded data of video data and audio data to the recording/playing unit 533 for example, and stores in the hard disk. At this time, the recorder control unit 526 and recording/playing unit 533 may perform processing such as re-encoding or the like, as necessary.

Also, the recorder control unit 526 decodes the encoded data of the video data and audio data that has been obtained, and supplies the obtained video data to the display converter 530. The display converter 530 processes video data supplied from the recorder control unit 526 in the same way as with video data supplied from the video decoder 525, supplies this to the monitor 560 via the display control unit 532, and displays the image thereof.

Also, an arrangement may be made wherein the recorder control unit 526 supplies the decoded audio data to the monitor 560 via the D/A converter 534 along with this image display, so that the audio is output from the speaker.

Further, the recorder control unit 526 decodes encoded data of the obtained EPG data, and supplies the decoded EPG data to the EPG data memory 527.

The hard disk recorder 500 such as described above uses the image decoding device 101 as the video decoder 525, decoder 552, and a decoder built into the recorder control unit 526. Accordingly, in the same way as with the image decoding device 101, the video decoder 525, decoder 552, and a decoder built into the recorder control unit 526 further calculate a cost function value between reference frames regarding the motion vector to be searched by the inter template matching processing between this frame and a reference frame. Thus, predictive accuracy can be improved.

Accordingly, the hard disk recorder 500 can generate prediction images with high precision. As a result, the hard disk recorder 500 can obtain decoded images with higher definition from, for example, encoded data of video data received via a tuner, encoded data of video data read out from the hard disk of the recording/playing unit 533, and encoded data of video data obtained via the network, and display this on the monitor 560.

Also, the hard disk recorder 500 uses the image encoding device 51 as the image encoder 551. Accordingly, as with the case of the image encoding device 51, the encoder 551 calculates a cost function value between reference frames regarding the motion vector to be searched by the inter template matching processing between this frame and a reference frame. Thus, predictive accuracy can be improved.

Accordingly, with the hard disk recorder 500, the encoding efficiency of encoded data to be recorded in the hard disk, for example, can be improved. As a result, the hard disk recorder 500 can use the storage region of the hard disk more efficiently.

While description has been made above regarding a hard disk recorder 500 which records video data and audio data in a hard disk, it is needless to say that the recording medium is not restricted in particular. For example, the image encoding device 51 and image decoding device 101 can be applied in the same way as with the case of the hard disk recorder 500 for recorders using recording media other than an hard disk, such as flash memory, optical discs, videotapes, or the like.

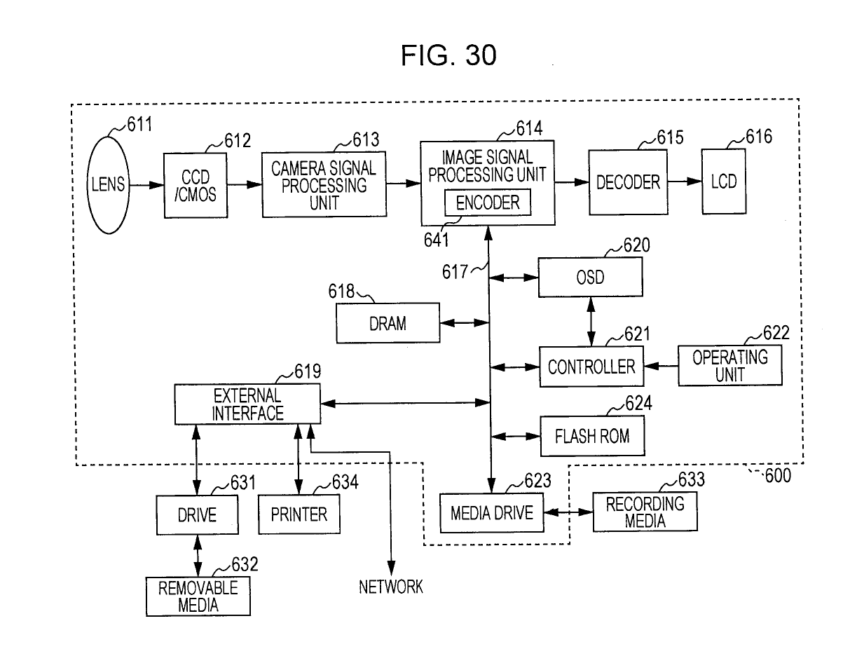

FIG. 30 is a block diagram illustrating an example of a primary configuration of a camera using the image decoding device and image encoding device to which the present invention has been applied.

A camera 600 shown in FIG. 30 images a subject and displays images of the subject on an LCD 616 or records this as image data in recording media 633.

A lens block 611 inputs light (i.e., an image of a subject) to a CCD/CMOS 612. The CCD/CMOS 612 is an image sensor using a CCD or a CMOS, which converts the intensity of received light into electric signals, and supplies these to a camera signal processing unit 613.

The camera signal processing unit 613 converts the electric signals supplied from the CCD/CMOS 612 into color different signals of Y, Cr, Cb, and supplies these to an image signal processing unit 614. The image signal processing unit 614 performs predetermined image processing on the image signals supplied from the camera signal processing unit 613, or encodes the image signals according to the MPEG format for example, with an encoder 641, under control of the controller 621. The image signal processing unit 614 supplies the encoded data, generated by encoding the image signals, to a decoder 615. Further, the image signal processing unit 614 obtains display data generated in an on screen display (OSD) 620, and supplies this to the decoder 615.

In the above processing, the camera signal processing unit 613 uses DRAM (Dynamic Random Access Memory) 618 connected via a bus 617 as appropriate, so as to hold image data, encoded data obtained by encoding the image data, and so forth, in the DRAM 618.

The decoder 615 decodes the encoded data supplied form the image signal processing unit 614 and supplies the obtained image data (decoded image data) to the LCD 616. Also, the decoder 615 supplies the display data supplied from the image signal processing unit 614 to the LCD 616. The LCD 616 synthesizes the image of decoded image data supplied from the decoder 615 with an image of display data as appropriate, and displays the synthesized image.

Under control of the controller 621, the on screen display 620 outputs display data of menu screens made up of symbols, characters, and shapes, and icons and so forth, to the image signal processing unit 614 via the bus 617.

The controller 621 executes various types of processing based on signals indicating the contents which the user has instructed using an operating unit 622, and also controls the image signal processing unit 614, DRAM 618, external interface 619, on screen display 620, media drive 623, and so forth, via the bus 617. FLASH ROM 624 stores programs and data and the like necessary for the controller 621 to execute various types of processing.

For example, the controller 621 can encode image data stored in the DRAM 618 and decode encoded data stored in the DRAM 618, instead of the image signal processing unit 614 and decoder 615. At this time, the controller 621 may perform encoding/decoding processing by the same format as the encoding/decoding format of the image signal processing unit 614 and decoder 615, or may perform encoding/decoding processing by a format which the image signal processing unit 614 and decoder 615 do not handle.

Also, in the event that starting of image printing has been instructed from the operating unit 622, the controller 621 reads out the image data from the DRAM 618, and supplies this to a printer 634 connected to the external interface 619 via the bus 617, so as to be printed.

Further, in the event that image recording has been instructed from the operating unit 622, the controller 621 reads out the encoded data from the DRAM 618, and supplies this to recording media 633 mounted to the media drive 623 via the bus 617, so as to be stored.

The recording media 633 is any readable/writable removable media such as, for example, a magnetic disk, magneto-optical disk, optical disc, semiconductor memory, or the like. The recording media 633 is not restricted regarding the type of removable media as a matter of course, and may be a tape device, or may be a disk, or may be a memory card. Of course, this may be a non-contact IC card or the like as well.

Also, an arrangement may be made wherein the media drive 623 and recording media 633 are integrated so as to be configured of a non-detachable storage medium, as with a built-in hard disk drive or SSD (Solid State Drive), or the like.

The external interface 619 is configured of a USB input/output terminal or the like for example, and is connected to the printer 634 at the time of performing image printing. Also, a drive 631 is connected to the external interface 619 as necessary, with a removable media 632 such as a magnetic disk, optical disc, magneto-optical disk, or the like connected thereto, such that computer programs read out therefrom are installed in the FLASH ROM 624 as necessary.

Further, the external interface 619 has a network interface connected to a predetermined network such as a LAN or the Internet or the like. The controller 621 can read out encoded data from the DRAM 618 and supply this from the external interface 619 to another device connected via the network, following instructions from the operating unit 622. Also, the controller 621 can obtain encoded data and image data supplied from another device via the network by way of the external interface 619, so as to be held in the DRAM 618 or supplied to the image signal processing unit 614.

The camera 600 such as described above uses the image decoding device 101 as the decoder 615. Accordingly, in the same way as with the image decoding device 101, the decoder 615 calculates a cost function value between reference frames regarding the motion vector to be searched by the inter template matching processing between this frame and a reference frame. Thus, predictive accuracy can be improved.

Accordingly, the camera 600 can generate prediction images with high precision. As a result, the camera 600 can obtain decoded images with higher definition from, for example, image data generated at the CC/CMOS 612, encoded data of video data read out from the DRAM 618 or recording media 633, or encoded data of video data obtained via the network, so as to be displayed on the LCD 616.

Also, the camera 600 uses the image encoding device 51 as the encoder 641. Accordingly, as with the case of the image encoding device 51, the encoder 641 calculates a cost function value between reference frames regarding the motion vector to be searched by the inter template matching processing between this frame and a reference frame. Thus, predictive accuracy can be improved.

Accordingly, with the camera 600, the encoding efficiency of encoded data to be recorded in the hard disk, for example, can be improved. As a result, the camera 600 can use the storage region of the DRAM 618 and recording media 633 more efficiently.

Note that the decoding method of the image decoding device 101 may be applied to the decoding processing of the controller 621. In the same way, the encoding method of the image encoding device 51 may be applied to the encoding processing of the controller 621.

Also, the image data which the camera 600 images may be moving images, or may be still images.

Of course, the image encoding device 51 and image decoding device 101 are applicable to devices and systems other than the above-described devices.

### REFERENCE SIGNS LIST

51 image encoding device
66 lossless encoding unit
74 intra prediction unit
77 motion prediction/compensation unit
78 inter template motion prediction/compensation unit
80 prediction image selecting unit
90 predictive accuracy improving unit
101 image decoding device
112 lossless decoding unit
121 intra prediction unit
124 motion prediction/compensation unit
125 inter template motion prediction/compensation unit
127 switch
130 predictive accuracy improving unit

1. An image processing device comprising:
first cost function value calculating means configured to determine, based on a plurality of candidate vectors serving as motion vector candidates of a current block to be decoded, a template region adjacent to said current block to be decoded in predetermined positional relationship with a first reference frame that has been decoded, and to calculate a first cost function value to be obtained by matching processing between a pixel value of said template region and a pixel value of the region of said first reference frame;
second cost function value calculating means configured to calculate, based on a translation vector calculated based on said candidate vectors, with a second reference frame that has been decoded, a second cost function value to be obtained by matching processing between a pixel value of a block of said first reference frame, and a pixel value of a block of said second reference frame; and
motion vector determining means configured to determine a motion vector of a current block to be decoded out of a plurality of said candidate vectors based on an evaluated value to be calculated based on said first cost function value and said second cost function value.

2. The image processing device according to claim 1, wherein in the event that distance on the temporal axis between a frame including said current block to be decoded and said first reference frame is represented as tn-1, distance on the temporal axis between said first reference frame and said second reference frame is represented as tn-2, and said candidate vector is represented as tmmv, said translation vector Ptmmv is calculated according to
Ptmmv=(tn−2/tn−1)×tmmv

3. The image processing device according to claim 2, wherein said translation vector Ptmmv is calculated by approximating (tn-2/tn-1) in the computation equation of said translation vector Ptmmv to a form of n/2^{m} with n and m as integers.

4. The image processing device according to claim 3, wherein distance tn-2 on the temporal axis between said first reference frame and said second reference frame, and distance tn-1 on the temporal axis between a frame including said current block to be decoded and said first reference frame are calculated using POC (Picture Order Count) determined in the AVC (Advanced Video Coding) image information decoding method.

5. The image processing device according to claim 1, wherein in the event that said first cost function value is represented as SAD1, and said first cost function value is represented as SAD2, said evaluated value etmmv is calculated by an expression using weighting factors α and β of
evtm=α×SAD1+β×SAD2.

6. The image processing device according to claim 1, wherein calculations of said first cost function and said second cost function are performed based on SAD (Sum of Absolute Difference).

7. The image processing device according to claim 1, wherein calculations of said first cost function and said second cost function are performed based on the SSD (Sum of Square Difference) residual energy calculation method.

8. An image processing method comprising the steps of:
determining, with an image processing device, based on a plurality of candidate vectors serving as motion vector candidates of a current block to be decoded, a template region adjacent to said current block to be decoded in predetermined positional relationship with a first reference frame that has been decoded, and calculating a first cost function value to be obtained by matching processing between a pixel value of said template region and a pixel value of the region of said first reference frame;
calculating, with said image processing device, based on a translation vector calculated based on said candidate vectors, with a second reference frame that has been decoded, a second cost function value to be obtained by matching processing between a pixel value of a block of said first reference frame, and a pixel value of a block of said second reference frame; and
determining, with said image processing device, a motion vector of a current block to be decoded out of a plurality of said candidate vectors based on an evaluated value to be calculated based on said first cost function value and said second cost function value.

9. An image processing device comprising:
first cost function value calculating means configured to determine, based on a plurality of candidate vectors serving as motion vector candidates of a current block to be encoded, with a first reference frame obtained by decoding a frame that has been encoded, a template region adjacent to said current block to be encoded in predetermined positional relationship, and to calculate a first cost function value to be obtained by matching processing between a pixel value of said template region and a pixel value of the region of said first reference frame;
second cost function value calculating means configured to calculate, based on a translation vector calculated based on said candidate vectors, with a second reference frame obtained by decoding a frame that has been encoded, a second cost function value to be obtained by matching processing between a pixel value of a block of said first reference frame, and a pixel value of a block of said second reference frame; and
motion vector determining means configured to determine a motion vector of a current block to be encoded out of a plurality of said candidate vectors based on an evaluated value to be calculated based on said first cost function value and said second cost function value.

10. An image processing method comprising the steps of:
determining, with an image processing device, based on a plurality of candidate vectors serving as motion vector candidates of a current block to be encoded, with a first reference frame obtained by decoding a frame that has been encoded, a template region adjacent to said current block to be encoded in predetermined positional relationship, and calculating a first cost function value to be obtained by matching processing between a pixel value of said template region and a pixel value of the region of said first reference frame;
calculating, with said image processing device, based on a translation vector calculated based on said candidate vectors, with a second reference frame obtained by decoding a frame that has been encoded, a second cost function value to be obtained by matching processing between a pixel value of a block of said first reference frame, and a pixel value of a block of said second reference frame; and
determining, with said image processing device, a motion vector of a current block to be encoded out of a plurality of said candidate vectors based on an evaluated value to be calculated based on said first cost function value and said second cost function value.
